(19) United States
(12) Patent Application Publication
(10) Pub. No.: US 2004/0135671 A1
(43) Pub. Date: Jul. 15, 2004

(54) Method and apparatus for interfacing with a point of sale device

(76) Inventors: Housh Khoshbin, Hawthorn Woods, IL (US); Kenneth J. Pavloski, Palos Heights, IL (US); Marc Shoemaker, (US); William Brown, (US)

Correspondence Address: James P. Muraff, Esq., WALLENSTEIN WAGNER & ROCKEY, LTD, 53rd Floor, 311 South Wacker Drive, Chicago, IL, 60606-6630, US

(21) Appl. No.: 10/662,133

(22) Filed: Sep. 12, 2003

Related U.S. Application Data
(63) Continuation-in-part of application No. 09/638,825, filed on Aug. 14, 2000.

(51) Int. Cl. H04Q 7/14

(52) U.S. Cl. 340/7.53; 705/14

(57) ABSTRACT

The present invention is a wireless device, such as a pager, that has an identity, such as a frequency and a capcode. The wireless device is provided for notifying a user of a message, such as a telephone number, directed specifically to the identity of the wireless device. The wireless device includes a housing, a display attached to the housing, a driver connected to the display for causing indicia to appear on the display, a controller, such as a microprocessor, connected to the driver for sending to the display a signal comprising indicia to appear on the display, a memory, and a receiver connected to the controller for receiving a page signal directed specifically to the identity of the wireless device and for communicating the page signal to the controller. When the controller receives the page signal received by the receiver, the controller sends to the driver a signal comprising the advertising indicia for causing the display to display the advertising indicia. The controller will then send to the driver a signal comprising message for display on the display. The wireless device further includes a dynamic infrared transfer system for transmitting information, such as financial information. A method is also provided in relation to the use of the wireless device.

### RELATED APPLICATION

This application is a Continuation-in-Part of U.S. Utility patent application Ser. No. 09/638,825, entitled “Method and Apparatus for Displaying Advertising Indicia on a Wireless Device,” filed Aug. 14, 2000. This application is incorporated herein by reference.

### TECHNICAL FIELD

The present invention generally relates to wireless devices for paging their users. More specifically, the present invention relates to a method and apparatus for displaying advertisements on a wireless device, such as a pager.

### BACKGROUND

Wireless devices, such as pagers, have become common. These wireless devices have allowed individuals to communicate more efficiently in business and personal settings. Typical pagers include a display for displaying a message, such as a phone number to return a call. Typical pagers also include a receiver which “listens” for its particular signal to be broadcast from a base station. Once the pager's individual signal is broadcast, the receiver in the pager will recognize the signal has been sent and will indicate an alarm to the user of the pager. The pager will then display the message on the display.

In the past, cards easy to use and convenient to carry were widely being used instead of cash. The cards may be a credit card, a cash card, an advance payment card or a direct payment card. For example, cards are frequently used to settle accounts. Recently, wireless devices have been used in combination with optical payment transceivers and optical payment systems for settling an expense. One particular type of system is disclosed in U.S. Patent Application No. 2002/0194137, with inventors Park et al. entitled “Optical Payment Transceiver And System Using The Same.” The Park optical transceiver provides a device for use in an optical transceiver apparatus for payment of expenses. The transceiver does not increase the speed of the transaction by using a modified Irda standard. Moreover, the transceiver is not capable to transmitting a plurality of coupons to a point of sale terminal.

One particular type of pager is disclosed in U.S. Pat. No. 5,999,088 issued to Sibbitt, entitled “Information Display Pager.” The Sibbitt pager provides a method and apparatus of providing active entertainment for persons waiting for service. Such persons are provided with an electronic pager assembly for notifying when service is available. The pager includes an electronically controllable pager assembly having a controllable screen display which is programmed with information likely to be desirable to a person holding the pager. A set of instructions enabling a person to access the information programmed in the pager assembly is printed on the assembly. The pager notification capability functions regardless of whether the information display is or is not active. The information is not automatically placed on the screen. Moreover, the user can choose to completely ignore the information within the pager and to wait until the pager “vibrates” as the notification that the user is ready to be seated in the restaurant.

Another particular type of pager is disclosed in U.S. Pat. No. 6,008,739, issued to Hymel, entitled “Increasing The Size Of Memory Available For Storing Messages In Response To The User Reading Advertisements In A Selective Call Receiver.” The Hymel patent is directed to a method of encouraging a user of an SCR (Selective Call Receiver) to read advertisements stored in the SCR. The user is provided with an initial level of access to a feature of the SCR that enhances the SCR's usefulness. When the user reads an advertisement, additional access to that feature is provided for a predetermined time period. Preferably, the feature is memory space, and each time the user reads an advertisement, the memory space available for storing messages is temporarily increased.

Another further particular type of pager is disclosed in U.S. Pat. No. 6,031,467, issued to Hymel et al., entitled “Method In a Selective Call Radio For Ensuring Reception Of Advertisement Messages.” The Hymel et al. patent discloses an SCR that receives personal messages and corresponding advertisement messages, and includes a receiver, memory, presentation circuit and processor. The processor is adapted to cause the receiver to receive a personal message, to determine whether a corresponding advertisement message has been previously stored in the memory, and in the event the corresponding advertisement message is not found, cause the presentation circuit to present the personal message to a user of the SCR. Additionally, the processor causes the presentation circuit to present a warning to the user that the SCR must receive the corresponding advertisement message within a predetermined time. If the corresponding advertisement message is not received within the predetermined time, the processor immediately disables the SCR. Thus, the advertisement messages can be lost when the pager is not on. In addition, a complicated structure is needed to ensure and encourage viewing of advertisement messages.

The present invention is provided to solve these and other problems.

### SUMMARY

The present invention is a wireless device, such as a pager, that has an identity, such as a frequency and capcode. The wireless device is provided for notifying a user of a page, such as a telephone number, directed specifically to the identity of the wireless device. The wireless device includes a housing and a display attached to the housing. The wireless device further includes a driver connected to the display for causing indicia to appear on the display. The wireless device further includes a controller, such as a microprocessor connected to the driver for sending to the display a signal comprising indicia to appear on the display. The wireless device also has a memory preprogrammed with advertising indicia and a receiver connected to the controller for receiving a page signal directed specifically at the identity of the wireless device and for communicating the page signal to the controller. When the controller receives the page signal received by the receiver, the controller will then send to the driver a signal comprising the advertising indicia preprogrammed in the memory for causing the display to display the advertising indicia. The controller will then send to the driver a signal comprising an identification of the message for display on the display.

The display can be a liquid crystal display (LCD) and the memory can be an electrically eraseable programmable read only memory (EEPROM). The advertising indicia can be a logo of a company, a company name, or other advertising indicia.

When the controller receives the page signal received by the receiver, the controller can then immediately send to the LCD driver a signal comprising the advertising indicia in the memory for causing the LCD to display the advertising indicia. The controller can then send to the LCD driver, within five seconds or less from the sending of the signal comprising the advertising indicia, a signal comprising the message.

In an additional embodiment of the present invention, the present invention is a memory device for a wireless device with its structure and functions generally as described. The memory device has a storage location preprogrammed with advertising indicia. When the controller receives the page signal received by the receiver, the controller will then send to the driver a signal comprising the advertising indicia preprogrammed in the memory for causing the display to display the advertising indicia, and the controller will then send to the driver a signal comprising an identification of the message for display on the display.

In a further embodiment of the present invention, the present invention is a method of providing advertising indicia to a user of a wireless device on the display of the wireless device. The wireless device notifies the user of a page directed specifically to an identity of the wireless device. The method comprises the steps of receiving an advertising request for placement of advertising indicia within the wireless device; storing in a memory located within the wireless device the advertising indicia, before the user obtains permanent possession of the wireless device; providing permanent possession of the wireless device to the user; and, providing paging service to the user. The user receives the page signal. The advertising indicia stored in the memory of the wireless device then appear on the display of the wireless device. The message then appears on the display of the wireless device.

In an additional embodiment of the present invention, the present invention is a method for providing advertising indicia to a plurality of users of wireless devices on a display of the wireless device. The wireless device notifies a user of a page directed specifically to an identity of the wireless device. The method comprises the steps of providing a plurality of wireless devices to an advertiser that may want to advertise to the users of the wireless devices, wherein each wireless device has an identity; receiving a request from the advertiser for placement of advertising indicia on a sub-set of the plurality of users of wireless devices wherein the request for placement of advertising indicia comprises a demographic criteria for selecting the sub-set; determining the identities of the sub-set for placement of the advertising indicia wherein the identities of the sub-set have user demographic information corresponding to the demographic criteria received from the advertiser; and, providing paging service to the plurality of users, wherein the wireless devices of the sub-set receive the advertising indicia and the advertising indicia appears on the display of the wireless devices of the sub-set.

In a further embodiment of the present invention, the present invention is a method for completing a commercial transaction. The method utilizes a system having a point of sale terminal and a wireless device for transmitting commercial information to the point of sale terminal. The method comprises the steps of providing for receiving a first infrared signal from a wireless device for establishing communication with the wireless device without utilizing at least one infrared standard procedure; providing for receiving a second infrared signal comprising the commercial information; and, providing for processing the second infrared signal. The at least one infrared standard procedure may comprise at least one of an address conflict resolution procedure and a sniff-open procedure. Further, the point of sale terminal may comprise an optical interface unit for receiving the first and second infrared signals and for communicating the commercial information to the point of sale terminal. The step of establishing communication may comprise at least one of a discovery procedure and a connection procedure. Further, the step of receiving the second infrared signal may comprise an information exchange procedure. The aforementioned discovery procedure may comprise an IRLAP Fast Connect Address discovery procedure. Moreover, the at least one infrared standard procedure may comprises at least one of an address conflict resolution procedure and a sniff-open procedure. Additionally, the method may comprise a step of completing the commercial transaction wherein the commercial information is coupon information. In this manner, the method may comprise the steps of providing for storing the coupon information as received coupon information; providing for comparing the received coupon information with recognized coupon information; providing for creating accepted coupon information comprising the received coupon information that matches with the recognized coupon information; providing for applying the accepted coupon information to the commercial transaction; providing for creating remaining coupon information comprising the received coupon information minus the accepted coupon information; providing for transmitting the remaining coupon information to the wireless device; and, providing for transmitting the accepted coupon information to the wireless device. Moreover, a method of securing the commercial information may be utilized comprising the steps of providing for receiving a random key index; providing for identifying an encryption key corresponding to the random key index; and providing for decrypting the commercial information utilizing the encryption key.

In a further embodiment of the present invention, the present invention is a system and method for providing a financial transaction to a user of a pager. The system includes an interactive point of sale terminal connected to an ATM network. The point of sale terminal comprises an input device for entering a personal identification number (PIN), an infrared receiver for receiving an infrared signal and an infrared transmitter for transmitting an infrared signal. The system further includes a wireless device for transmitting an infrared signal to the interactive point of sale terminal. The wireless device comprises an identification corresponding to a personal identification number, a memory comprising financial information, a processor connected to the memory for processing the financial information and wireless device identification to form an infrared transaction signal, and a transmitter connected to the processor for transmitting the infrared transaction signal to the interactive point of sale terminal.

In an additional embodiment of the present invention, the present invention is a system for permitting access to a device having controller access. The system comprises an access control system connected to a device requiring controlled access. The access control system has an infrared receiver for receiving an infrared signal. The system further includes a wireless device for transmitting an infrared signal to the access control system. The wireless device comprises an identification, a memory comprising identification information, a processor connected to the memory for processing the identification information to form an infrared signal, and a transmitter connected to the processor for transmitting the infrared signal to the access control system.

In an additional embodiment of the present invention, the present invention is a method for providing advertising indicia to a sender of a page to a user of a wireless device. The wireless device notifies the user of a page directed specifically to an identity of the wireless device. The method comprises the steps of providing a plurality of wireless devices to an advertiser that may want to advertise to a sender of a page to one of a plurality of users of the wireless devices wherein each wireless device has an identity; receiving a request from the advertiser for placement of an audible advertising message on a voice mail system; and, providing the audible advertising message to the sender of the page in response to the sender of the page requesting to leave a voice mail message directed specifically to the identity of the wireless device of the user.

In an additional embodiment of the present invention, the present invention is a method for providing advertising to a sender of a page to a user of a wireless device. The wireless device notifies the user of a message directed specifically to an identity of a wireless device. The method comprises the steps of providing a website to the sender for sending the page to the user of the wireless device, the website having a field for identifying the identity of the wireless and a field for identifying the message; receiving a request from the advertiser for placement of advertising indicia through the website; and, displaying the advertising indicia in response to the sender transmitting a page to a specific identity of the wireless device.

Other features and advantages of the present invention will be apparent from the Figures, Detailed Description, and claims below. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is one embodiment of a wireless device of the present invention.

FIG. 2 is a block diagram of one embodiment of the process of implementing advertising indicia into the wireless device of the present invention.

FIG. 3A is an illustration of the main menu presenting the personal messages folder of the present invention.

FIG. 3B is an illustration of the individual messages stored in the personal messages folder of the present invention.

FIG. 3C is an illustration of the selected message stored in the personal messages folder of the present invention.

FIG. 4 is a memory allocation of one embodiment of the wireless device of the present invention.

FIG. 5 is a flow diagram of one embodiment of what appears on the display of the wireless device of the present invention.

FIG. 6A is an illustration of the main menu presenting the Maildrop messages folder of the present invention.

FIG. 6B is an illustration of the channel selection screen highlighting the Sports Channel stored in the Maildrop messages folder of the present invention.

FIG. 6C is an illustration of the channel selection screen highlighting the News Channel stored in the Maildrop messages folder of the present invention.

FIG. 6D is an illustration of the channel selection screen highlighting the Stocks Channel stored in the Maildrop messages folder of the present invention.

FIG. 6E is an illustration of the channel selection screen highlighting the Custom Channel stored in the Maildrop messages folder of the present invention.

FIG. 7A is an illustration of the individual Maildrop messages stored in the Maildrop messages folder of the present invention.

FIG. 7B is an illustration of the selected Maildrop message stored in the Maildrop messages folder of the present invention.

FIG. 8 is a block diagram of the dynamic infrared transfer system of the present invention.

FIG. 9 is a block diagram of one embodiment of the wireless device utilized in the dynamic infrared transfer system of the present invention.

FIG. 10 is an illustration of a transceiver of the wireless device in FIG. 9 of the present invention.

FIG. 11 is a block diagram of one embodiment of a sidekick unit utilized in the dynamic infrared transfer system of the present invention.

FIG. 12 is an overview of the phases utilized to transfer information between optical devices.

FIG. 13 illustrates one embodiment of a format of a frame of the present invention.

FIG. 14 is one embodiment of an address field of the present invention.

FIG. 15 is an illustration of one embodiment of an estimated timing diagram for completing the discovery phase of the present invention.

FIG. 16 is an illustration of one embodiment of an estimated timing diagram for completing the optical connection of the present invention.

FIG. 17 is an illustration of one embodiment of an estimated timing diagram for completing the optical information phase of the present invention.

FIG. 18 is an illustration of a universal asynchronous receiver/transmitter timing diagram of the present invention.

FIG. 19 is an illustration of an optical transmit timing diagram of the present invention.

FIG. 20 is an illustration of one embodiment of a coupon stock keeping unit data of the present invention.

FIG. 21 is a flowchart of data encryption and data decryption of the present invention.

FIG. 22A is an illustration of the main menu presenting the Coupon Channel of the present invention.

FIG. 22B is an illustration of the individual coupons stored in memory of the present invention.

FIG. 22C is an illustration of the selected coupon stored in the coupon memory of the present invention.

FIG. 23A is an illustration of the main menu presenting the Payment Channel of the present invention.

FIG. 23B is an illustration of a merchant payment option of the present invention.

FIG. 23C is an illustration of a VISA credit card payment option of the present invention.

FIG. 23D is an illustration of a MasterCard credit card payment option of the present invention.

FIG. 23E is an illustration of a Discover credit card payment option of the present invention.

FIG. 24 is a block diagram of the access control system of the present invention.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

### Hardware

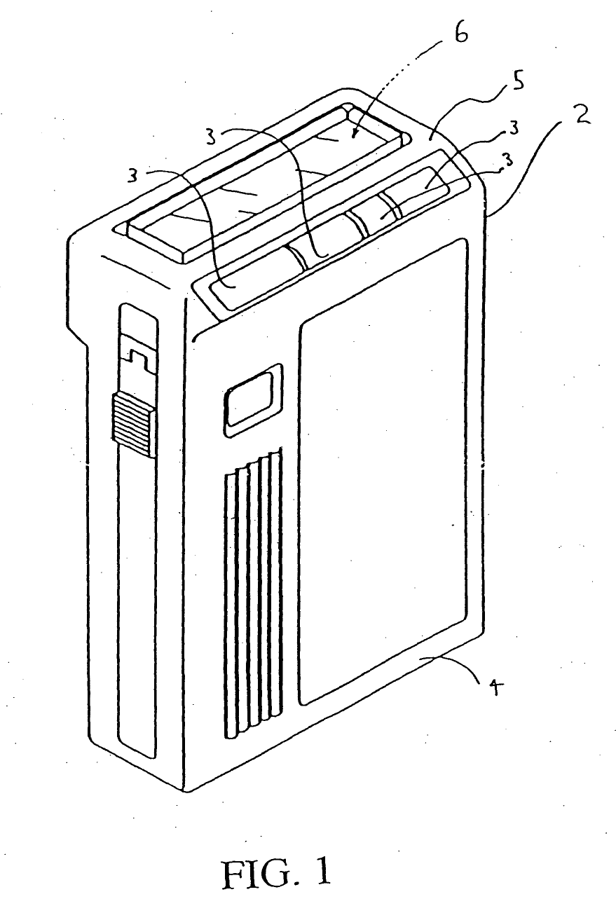

With reference to FIG. 1, one form of a wireless device 2, such as a pager, is shown. The wireless device 2 may be a device comprising a mobile or computing device capable of electronic wireless communication and having a processor and memory such as a personal digital assistant (PDA), handheld computer, laptop computer, notebook computer, wireless appliance. These devices may include a stylus or keypad for controlling their operation and entering information, as well as a viewable display, and sound. The device may also carry a microphone for use with known voice recognition equipment and software included in the device. Finally, a mobile communication device such as a mobile or cellular phone may be operate as the wireless device 2.

The pager 2 has an identity in the form of a frequency or small frequency range with which signals are sent to the pager 2, and which the pager 2 will recognize and respond to. The pager 2 is used for notifying a user of a page directed specifically to the pager 2. The page can be a person or a number to reach the person sending the page. The pager 2 has a housing 4 and a display 6 attached to the housing 4. The display 6 may be a liquid crystal display (LCD). The pager 2 includes a plurality of buttons 3 for allowing the user to control operation of the pager 2, such as selecting a message to read or a folder to open. The buttons 3 may be soft buttons thereby allowing their functions can be changed or modified allowing different screens to utilize different functions for the same buttons. The display 6 and the plurality of buttons 3 create an interface 5 by which the user operates the pager 2.

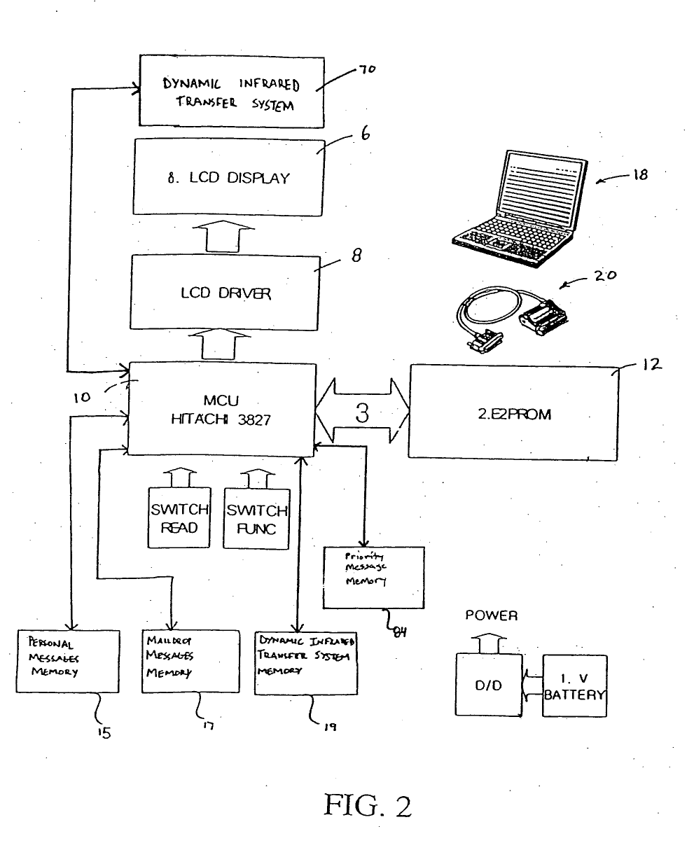

With further reference to FIG. 2, a display driver 8 is electrically connected to the display 6 for causing indicia to appear on the display 6. The display driver 8 may be a liquid crystal display driver. A controller or microprocessor 10 is connected to the display driver 8 for sending to the display 6 a signal that has indicia therein. In one form of the present invention, the controller 10 is an MCU Hitachi 3827 microprocessor. The controller 10 and the display driver 8 work together, as one of ordinary skill in the art would understand, to cause the indicia to appear on the display 6. The pager 2 also has an electrically erasable programmable read only memory (EEPROM) 12. The EEPROM 12 is preprogrammed with advertising indicia, as will be further described below. The preprogrammed advertising indicia therein can be changed, when the EEPROM 12 or other such changeable memory is used. The pager 2 further includes a personal messages memory 15 for storing messages received by the pager 2. The pager 2 has an audible and/or vibrating alarm for notifying the user when a page is taking place or has taken place. The pager 2 further comprises a power source for powering the controller 10, the display 6, and other components needing a power source. A receiver is electrically connected to the controller, as one of ordinary skill in the art would understand, for receiving a page signal directed specifically at the identity of the pager 2. The receiver will communicate the page signal to the controller 10 and the alarm for notifying the user of the page.

### Receiving a Page

In one form of the present invention, when the controller 10 receives the page signal sent to the controller 10 by the receiver, after the receiver receives the signal, the controller 10 immediately sends to the display driver 8 a signal comprising the advertising indicia in the EEPROM 12 for causing the display 6 to display the advertising indicia. The advertising indicia can be the name of a company, a logo, or some other form of advertising indicia. Further, the advertising indicia may be a full motion graphic, such as a FLASH graphic. The controller 10 will then send to the display driver a signal comprising a message, such as a number or person's name, or both. Preferably, the signal comprising the message it sent to the display driver 8 within five seconds or less from the sending of the signal comprising the advertising indicia. In this way the user of the pager 2 does not have to wait an unnecessary amount of time, with the understanding that the user knows it has received the pager and the paging service for little or no charge.

In an even further embodiment of the present invention, the controller 10 can be programmed such that the advertising indicia 16 will appear on the display 6 for a selected length of time before the message is displayed on the display 6. As described above, the pager 2 has an audible and/or vibrating alarm for notifying a user when a page is taking place, or has taken place. The programmable time for the advertising indicia to be displayed in the display 6 can begin after the audible alarm is complete. Alternatively, the time that the advertising indicia are displayed on the display can begin about the same time as an alarm begins. These programmable features allow for flexibility in meeting the requests and demands of companies and individuals wishing to place advertising within a wireless device.

In another form of the invention, when the controller 10 receives the page signal received by the receiver, the pager 2 enters a NEW MESSAGE RECEIVED mode. In the case of the NEW MESSAGE RECEIVED mode, the user can wait to view the message until a later time after the alarm indicates the page has been received. The user can then press one of the buttons 3 to select to view the message. When the user selects to do this, the advertising indicia will be displayed on the display 6 in the manner described above.

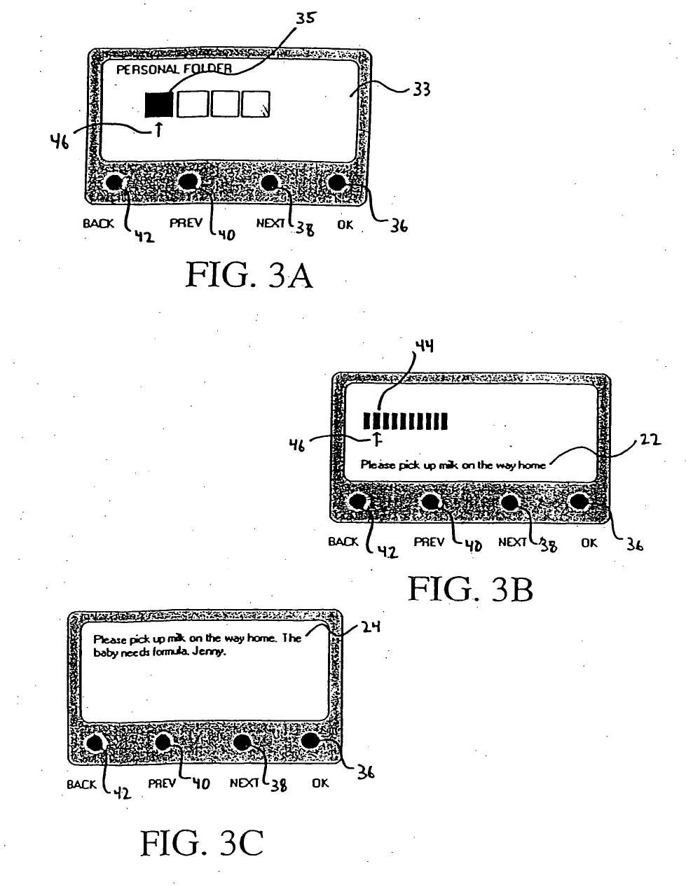

After the first viewing of the advertising indicia and associated message, the user can choose to keep the message in a personal messages memory 15 which is accessed via the interface 5 as the Personal Folder 35 from the Main Menu 33 as seen in FIG. 3A. In order to view a stored message, the user depresses a control button 3. In response, the pager 2 displays a screen as seen in FIG. 3A, allowing the user to access control functions relevant to the screen/function presented. Depressing the “OK” button 36 selects the Personal Message Memory section 15 and displays a new screen as seen in FIG. 3B. The display of FIG. 3B shows the individual messages stored in the personal message memory section 15. Using the “NEXT” button 38 and the “PREV” button 40, the user can navigate the cursor 46 through the full range of indicators 44. To assist the user in selecting messages, the screen additionally displays, below the message indicators 46, a single text line 22 detailing the beginning of the relevant message indicated. This allows the user to glance at the first part of the message stored in the personal message memory 15 and scroll from slot to slot to find a selected message of interest. Depressing the “OK” button 36 allows the user to display the selected message on the display 6, as seen in FIG. 3C.

FIG. 3C shows a selected message 24 stored in the personal messages memory 15 being displayed on the display 6 of the pager 2. Upon the selected message 24 being displayed, the functionality of the “NEXT” button 38 and “PREV” button 40 change so that depressing the NEXT button 38 moves the display screen forward so as to show subsequent screens of the message 24. When the end of the current message 24 is reached, a depression of the NEXT button 38 displays the first screen of the next message in that direction. Similarly, depressing the PREV button 40 moves the display screen backwards in the current message 24 until the beginning of the current message 24. When the beginning of the current message 24 is a reached, depressing PREV button 40 will display the first screen of the message in the previous direction. Depressing the BACK button 42 moves the user up a level in the menu system as seen in FIG. 3B thus allowing the user to move through the full range of indicators 44 and selecting individual messages to be viewed. It should be noted the “OK” button 36, “NEXT” button, 38, “PREV” button 40, and “BACK” button 42 may be arranged in any manner.

### Storing the Advertising Indicia in Memory

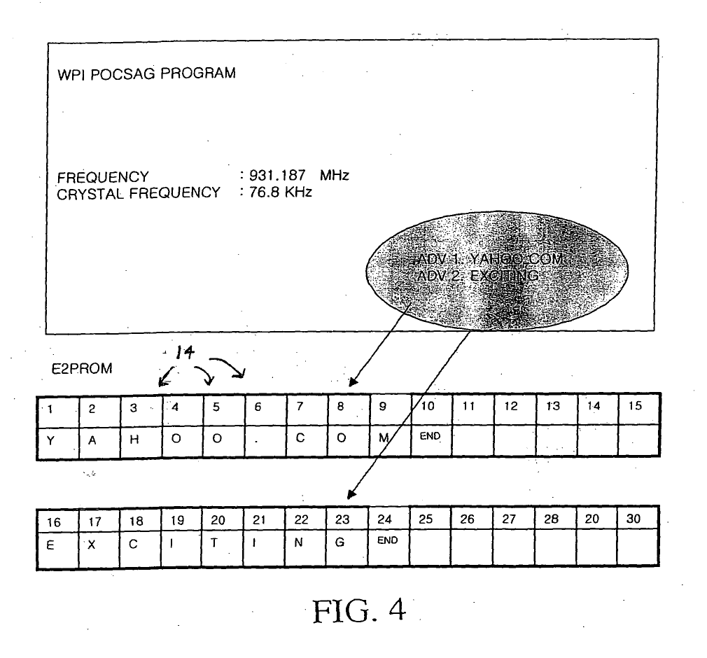

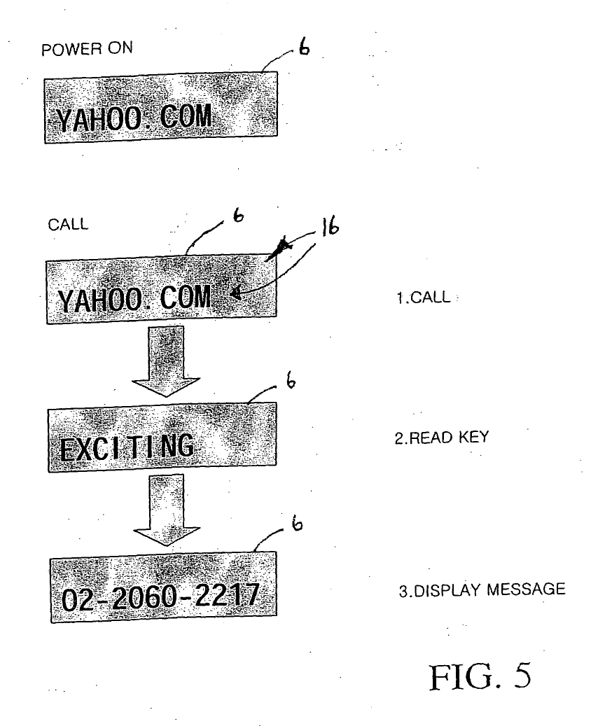

In the embodiment in FIG. 4-FIG. 5, the memory device has several storage locations 14, at least one of which is preprogrammed with advertising indicia. FIG. 4 depicts the company name “YAHOO.COM” (see FIG. 5) preprogrammed in the storage location 14. It should be noted that the advertising indicia may be of a non-commercial manner. As described above, when the controller 10 receives the page signal received by the receiver, the controller 10 sends to the driver 8 a signal comprising the advertising indicia preprogrammed in the memory 12 for causing the display 6 to display the advertising indicia. Thereafter, the controller 10 will send to the driver 8 a signal comprising the message for display on the display 6. As will be described further below, the advertising indicia is preprogrammed, at either the factory or assembly facility where the pager 2 is manufactured, or where the pager 2 is distributed, such as a wholesaler or retailer.

In one embodiment of the present invention, the sellers of the pager devices, in order to make the price more reasonable for the user, if at any price at all, contract directly with a company or person wishing to advertise a product, name, service, or other thing representable through indicia. The seller can, thus, receive a request for placement of advertising indicia within the wireless device 2. The seller or other entity will then store in the memory 12 of the wireless device 2 the advertising indicia. This is done before the user obtains permanent possession of the wireless device, although it can be done after the user has identified in a store or otherwise, which pager 2 the user is interested in using and receiving on a permanent basis. Once the seller has programmed the advertising indicia 16 within the pager 2, the seller provides the wireless device to the user on a permanent basis. This can be done on a no-charge basis. The paging service will then be provided to the user such that when the user receives the page from the source, the advertising indicia 16 stored in the memory 12 of the wireless device 2 will appear on the display 6, in the manner described above.

As mentioned above, the seller of the pager 2 can program the advertising indicia 16 into the pager 2. This can be accomplished by connecting a personal computer 18 to the wireless device 2. This connection may be remote or local and through, for example, an RF connection. Other remote/local means can be used as well. One example of a local means can be a cable 20. The cable 20 can connect through a serial port in the personal computer 18 at one end of the cable 20 and to an EEPROM programming board, having an EEPROM 12 thereon, at the other end of the cable 20. Software is then run on the personal computer 18 that allows for communication between the personal computer 18 and the EEPROM 12 that is then placed in the wireless device 2. Alternatively, the other end of the cable 20 can be directly connected to the wireless device 2. The seller then enters the advertising indicia 16 into the software running on the personal computer 18, and the advertising indicia 16 is then sent to the wireless device 12 from the personal computer 18 for storage in the memory 12, either directly or indirectly through the use of the EEPROM programming board. The connection between the personal computer 18 and the wireless device is then disconnected, either directly or indirectly from the EEPROM programming board.

The advertiser 34 can pay for some or all of the wireless device or associated paging service, if needed. Several different advertising indicia can be preprogrammed into memory before the user receives permanent possession thereof. In a further embodiment of the present invention, when a first page is received, a first advertising indicia, such as “YAHOO.COM” stored in memory 12 can be displayed on the display 6 of the wireless device 2. When a second page is received, a second advertising indicia, such as “COKE” stored in memory 12 can be displayed on the display 6 of the wireless device 2. When more than one advertising indicia are preprogrammed into memory 12, the advertising indicia can alternate being displayed on the display 6. In an even further embodiment, the controller 10 of the wireless device 2 can be programmed to cause the first advertising indicia to appear on the display a particular percentage of the time of the overall number of pages for a given time period. For example if YAHOO and COKE placed advertising requests, and YAHOO paid more than COKE, then the wireless device 2 could be programmed to have a cycle with four slots, and YAHOO would take up three of the four slots, with COKE taking up the fourth slot. Thus, YAHOO would appear three times in a row, for the first three pages, and COKE would come up on the fourth page. This cycle can be repeated. Other numbers of slots in one cycle could also be used. Other programming methods come to mind of one of ordinary skill in the art, so long as the proper percentage of appearances is achieved.

### Maildrop Function/Private Channel

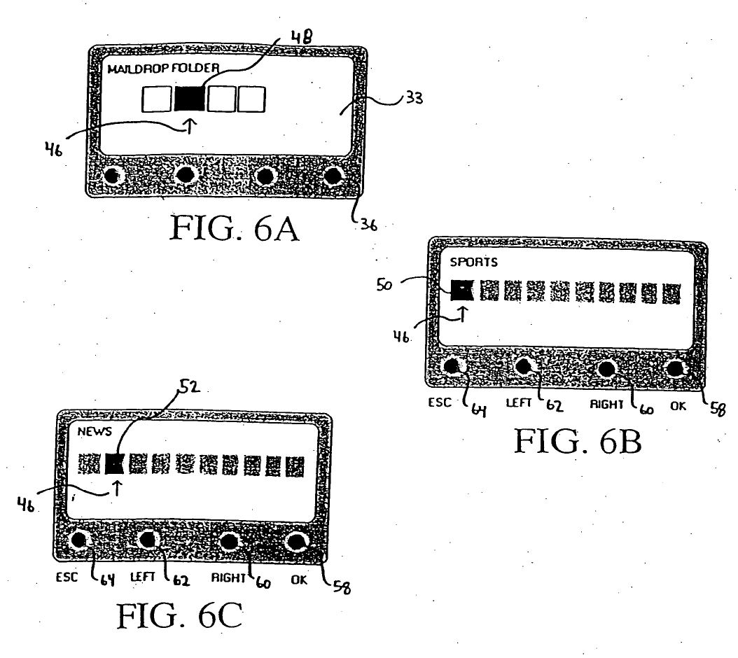

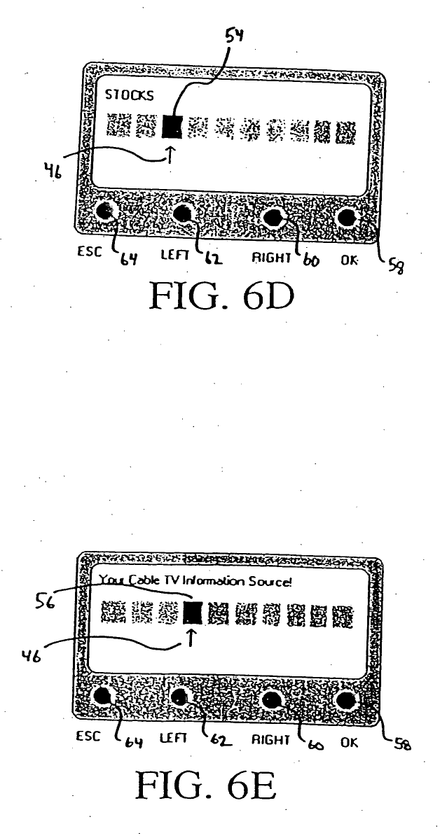

The pager 2 further includes a plurality of channels such as the Maildrop Message Channel, Coupon Channel, and Payment Channel. The Maildrop Message Channel presents advertising messages, rather than personal text messages as described above. The advertising messages are stored in a Maildrop messages memory 17 and are accessed via the interface 5 as the Maildrop Folder 48 as seen in FIG. 6A. Selecting the Maildrop Folder 48 opens a new menu screen presenting a plurality of selected Maildrop Message Channels thereof as seen in FIG. 6B-FIG. 6E. The plurality of Maildrop Message Channels may include a Sports Channel 50, a News Channel 52, a Stocks Channel 54, and other Custom channels 56, such as Cable TV Information Source. In addition, the Maildrop Message Channel may include the Coupon Channel and the Payment Channel. It should be noted that the Custom channels 56 would change, dependent upon the advertiser's 34 custom requirements and the demographic criteria of the user of the pager 2, described hereinafter.

The different categories described above are referred to as capcodes. The capcodes are presented to the user as menu selections. One embodiment of the capcodes and menu selections of the present invention are illustrated below:

| Capcode | Menu Option |
|---|---|
| 1 | Primary |
| 2 | Main Maildrop |
| 3 | News |
| 4 | Sport |
| 5 | Info 1 |
| 6 | Info 2 |
| 7 | Info 3 |
| 8 | Info 4 |
| 9 | Info 5 |
| 10 | |
| 11 | |
| 12 | |
| 13 | |
| 14 | |
| 15 | |
| 16 | |

Individual pager 2 Maildrop Message Channels may be programmed over the air (OTA) via an identification. After a user has purchased the pager 2, the pager 2 is activated. This activation may be done via the Internet or over the telephone. When activating the pager 2, the user supplies personal demographic information, such as age, gender, and/or profession. The personal demographic information is utilized to assemble the identification of the data that may be transmitted to the various capcodes. This identification is transmitted OTA to the pager 2, thereby programming the Custom channels 56 to receive Maildrop messages intended for members of a sub-set of users that an advertiser 34 wishes to contact.

When the advertiser 34 wishes to contact a sub-set of users, a request is received from the advertiser 34 for placement of a select Maildrop message 26 on the sub-set of users. Confirmation of the receipt of the request is transmitted back to the advertiser. The request Comprises the requisite demographic criterion of the sub-set of users thereby allowing Identification of the capcodes corresponding to the demographic criterion received from the advertiser 34. In a further embodiment, the request comprises a plurality of different demographic criterion for selecting the sub-set. A page signal is then transmitted such that the wireless devices 2 of the sub-set receive the page signal comprising the selected Maildrop message 26. When the controller 10 receives a page signal comprising the selected Maildrop message 26 received by the receiver, the controller 10 sends a signal to the alarm for notifying to the user that a page has taken place. The controller 10 further sends to the display driver a signal for causing the display 6 to display an identification of the channel from wherein the Maildrop message 26 can be accessed. The Maildrop message 26 is stored in the appropriate channel location in the Maildrop message memory 17 and can be accessed in the manner described above.

In a further embodiment of the present invention, an individual Maildrop Message Channel, such as the Custom Channel 56 may be programmed with the name of a selected advertiser as seen in FIG. 6E. In such circumstances, this Private Channel is reserved for messages originating from a select Private Channel sponsor and allows the Private Channel sponsor to have constant communication with the user of the pager 2. In this manner, it is possible for the Private Channel sponsor to advertise to a select group of users at any time.

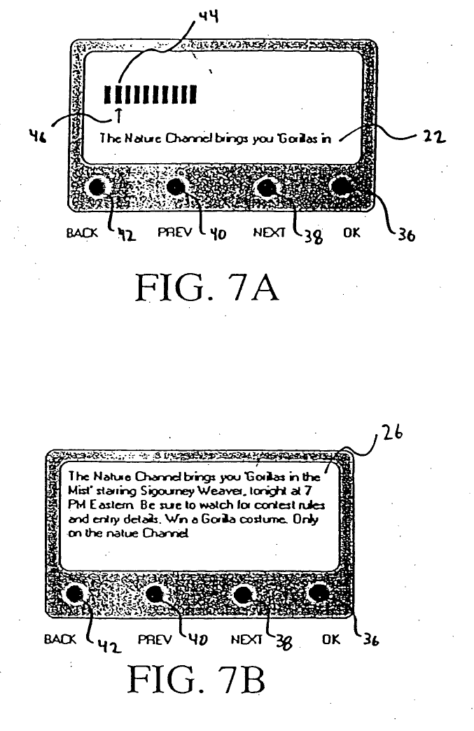

FIG. 6A-FIG. 6E and FIG. 7A-FIG. 7B display the method utilized to read a Maildrop message stored in the Maildrop message memory 17 via Maildrop Folder 48. The access and presentation of the Maildrop message from the Maildrop message memory 17 is similar to the access of the personal message from the personal messages memory 15. In order to view the Maildrop message, the user selects the Maildrop Folder 48 from the Main Menu 33 by depressing the “OK” button 36 as seen in FIG. 6A. In response, the pager 2 displays a screen as seen in FIG. 6B-FIG. 6E allowing the user to access the plurality of Maildrop Message Cannels. The user may utilize the “RIGHT” button 60 and the “LEFT” button 62 to navigate the cursor 46 through the full range of Maildrop Message Channels. To assist the user in selecting a Maildrop Message Channel, the screen additionally displays, above the message channel indicators 50,52,54,56, the title of the selected Maildrop Message Channel. Depressing the “OK” button 58 displays the selected Channel on a new screen as seen in FIG. 7A.

FIG. 7A and FIG. 7B show the method of how a Maildrop message is presented to the user. The display 6, as seen in FIG. 7A, shows the individual Maildrop messages stored in the Maildrop Message Channel 56 of FIG. 6E. Using the “NEXT” button 38 and the “PREV” button 40, the user can navigate the cursor 46 through the full range of indicators 44. To assist the user in selecting messages, the screen additionally displays, below the indicators 44, a single line of text 22 detailing the beginning of the relevant Maildrop message indicated. This allows the user to glance at the first part of the message stored in the Maildrop message memory 17 and scroll from slot to slot to find a selected message of interest. Depressing the “OK” Button 36 allows the user to display the selected message 26 on the display 6, as seen in FIG. 7B.

FIG. 7B shows a selected message stored in the Maildrop messages memory 17 being displayed on the display 6 of the pager 2. Upon the selected message 26 being displayed, the functionality of the “NEXT” button 38 and “PREV” button 40 change so that depressing the NEXT button 38 moves the display screen forward so as to show subsequent screens of the message 26. When the end of the current message 26 is reached, a depression of the NEXT button 38 displays the first screen of the next message in that direction. Similarly, depressing the PREV button 40 moves the display screen backwards in the current message 26 until the beginning of the current message. When the beginning of the current message 26 is a reached, depressing PREV button 40 will display the first screen of the message in the previous direction. Depressing the BACK button 42 moves the user up a level in the menu system as seen in FIG. 7A, thereby permitting navigation through the full range of messages and selection of individual messages to be viewed.

### Dynamic Infrared Transfer System

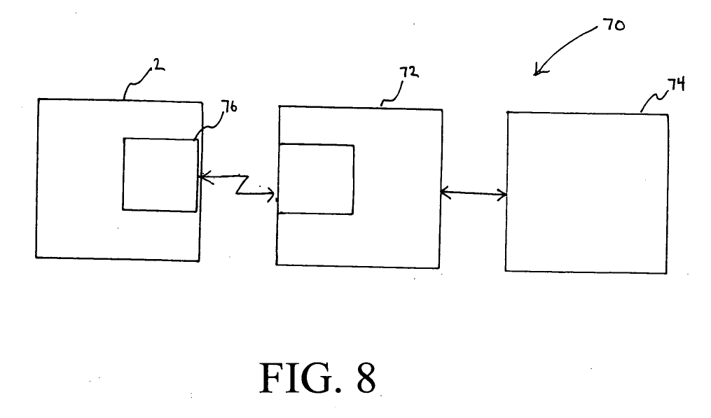

In a further embodiment of the present invention, a dynamic infrared transfer system 70 utilizes the wireless device 2 as means to transfer and receive data via electromagnetic signals, such as optical signals. With reference to FIG. 8, in the preferred embodiment the dynamic infrared transfer system 70 includes the wireless device 2, an interfacing unit 72 such as optical interfacing unit or a sidekick unit, and a point of sale terminal 74. The dynamic infrared transfer system 70 is an enhancement that allows a user of the wireless device 2 to make a commercial transaction such as a coupon transaction or a financial transaction over a wireless interface to the point of sale terminal 74. Preferably, the wireless device 2 may maintains all of the features and capabilities described above. In addition, an optical transceiver such as an infrared transceiver 76 is added to the wireless device 2. The wireless device 2 communicates transaction data via the infrared transceiver 76 to the sidekick unit 72. The sidekick unit 72 acts as the interface between the wireless device 2 and the point of sale terminal 74. The sidekick unit 72 stores and processes transaction data received from the wireless device 2 and transfers at least a portion of the transaction data to and from the point of sale terminal 74 to complete the transaction.

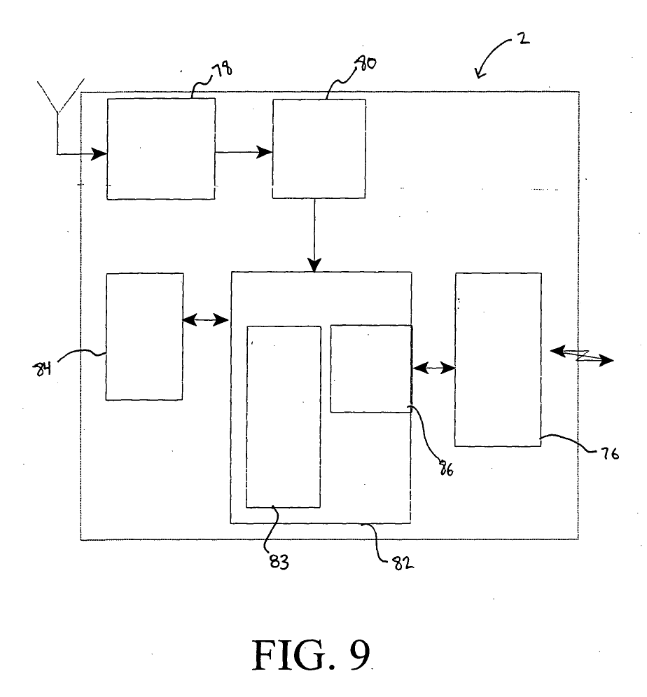

One embodiment of a block diagram for the wireless device 2 having an infrared transceiver 76 is shown in FIG. 9. The wireless device 2 processes incoming messages over a radio frequency channel. The wireless device 2 includes radio frequency component 78, an interfacing chip 80, processor 82, and memory 84. The radio frequency component 78 processes the incoming signal. The interfacing chip 80 is preferably a Flex Chip and interfaces the radio frequency component 78 with the processor 82. The processor 82 performs the necessary functions to complete the message transaction.

As mentioned above, the wireless device 2 has memory 84 having various types of personal information data stored therein. The wireless device 2 utilizes the memory 84 to copy selected transfer data and configures the data for transmission via the infrared transceiver 76, in a manner known by one of ordinary skill in the art. The selected transfer data may be buffered in an on-chip memory 83 of the processor 82 of the wireless device 2. The transmitter IR LED 92 utilizes invisible modulated infrared light as a transmission medium thereby avoiding problems associated with radio frequency (RF) interference and electromagnetic radiation (EMR) interference.

As noted, the wireless device 2 includes an infrared transceiver 76 which interfaces with a universal asynchronous receiver-transmitter infrared interface 86 of the processor 82. The transceiver 76 may be added as an enhancement to an existing device such that the existing device provides the necessary power, control, and export leads, such as data export leads. Alternately, it is possible for the infrared transceiver 76 to be configured with a dedicated control system such that it operates independently of the wireless device's 2 functionality. Further, due to the high-speed and short range of data transfer in the dynamic infrared transfer system 70, a standard IrDA data protocol may be utilized. However, the inherent flexibility of the dynamic infrared transfer system 70 permits the wireless device 2 to accept a complete spectrum of defined data types and data protocols.

The transceiver 76 may include a transmitter module and a receiver module. The transceiver 76 comprises an infrared light emitting diode (IR LED) 92, an integrated circuit (IC) chip 94 having an IC memory and data encryption software connected to the IR LED 92 for driving the IR LED 92, and a user interface 5 section for operating the transceiver 76. Preferably, the receiver module utilizes the same IC chip 94 and user interface 5 as the transmitter module 88; however, the receiver module may utilize a separate IC chip and a separate interface.

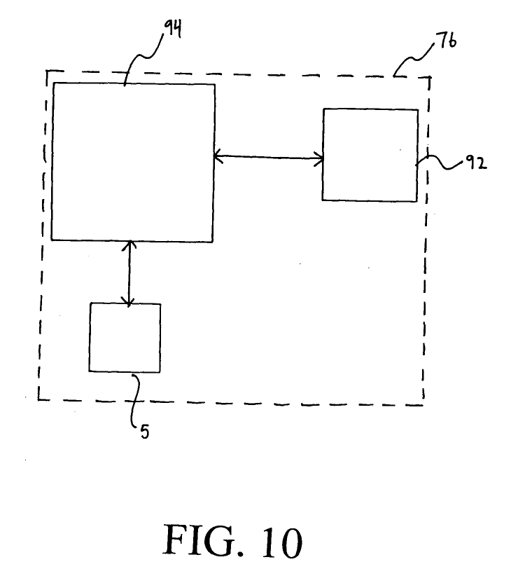

With reference to FIG. 10, the receiver module utilizes an IR LED 92 and an integrated circuit (IC) chip 94 having an IC memory and data decoding software connected to the IR LED 92 for decoding data received by the IR LED receiver 98. Upon receiving data by the IR LED 92, the IC chip 94 transmits the received data to the memory 84. Preferably, the data is transferred via a RS232 standard serial interface thereby allowing the dynamic infrared transfer system 70 to be utilized with a plurality of host systems in addition to the wireless device 2. The IC chip 94 further decodes the received data so that the wireless device 2 may utilize it. The addition of the receiver module allows for flexibility of application of the dynamic infrared transfer system 70 such that data intended for transport via the dynamic infrared transfer system user interface 5 can be loaded into the wireless device 2 via the infrared transfer in addition to traditional input means, such as RF signals.

As noted above, the dynamic infrared transfer system 70 includes the interfacing unit 72, such as the optical interfacing unit interfacing the wireless device 2 with a point of sale terminal 74. The optical interfacing unit 72 may be capable of multitasking communication between the wireless device 2 and the point of sale terminal 74 thereby communicating with the point of sale terminal 74 and the wireless device 2 simultaneously. The optical interfacing unit 72 may be, for example, a general purpose computer that is capable of wireless electronic communication, such as infrared communication. The optical interfacing unit may have voice recognition capability, as well as a display, a microphone, and a keyboard, all of which may be used for entering and retrieving information.

Wireless communication between the interfacing unit 72 and the wireless device 2 may be accomplished using one or more known communication application protocols, such as Wireless Application Protocol (WAP), Bluetooth, Infrared (IrDA), 802.11, as well as other communication and application protocols known to those skilled in the art. Each of these protocols is herein incorporated by reference. The interfacing unit 72 and wireless device 2 each include communication hardware and software known in the art for implementing these protocols.

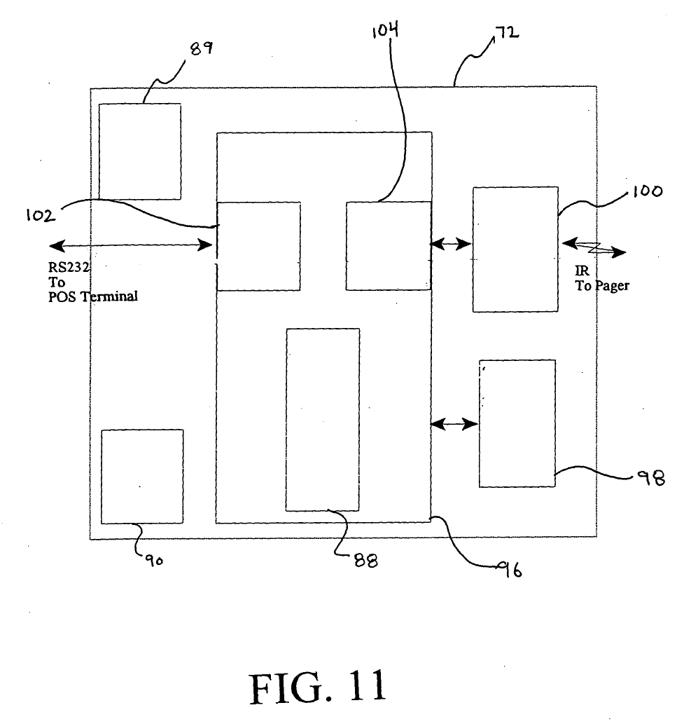

Preferably, the interfacing unit 72 is an optical interfacing unit and receives data from the wireless device 2 via an infrared transmission. With reference to FIG. 11, the optical interfacing unit 72 includes a processor 96, a memory 98, and an infrared transceiver 100 for communicating with the wireless device 2. The processor 96 includes a universal asynchronous receiver-transmitter (UART) interface 102 for interfacing the optical interfacing unit 72 to the point of sale terminal 74. Preferably, the universal asynchronous receiver-transmitter interface 102 is a standard interface such as RS-232, however other interfacing techniques are possible. In addition, the processor 96 has a universal asynchronous receiver-transmitter (UART) infrared interface 104 for interfacing the optical interfacing unit 72 with the wireless device 2. Additionally, the optical interfacing unit 72 may include an on-chip memory 88, a power source 90, and/or a reset 89.

The UART infrared interface 104 of the processor 96 may interface with the wireless device 2 utilizing a standard Irda protocol or a derivative thereof as will be described herein. The derivative protocol may be a subset of the provisions provided for by the Infrared Data Association Serial Infrared Link Access Protocol IrLap 1.1, incorporated herein by reference.

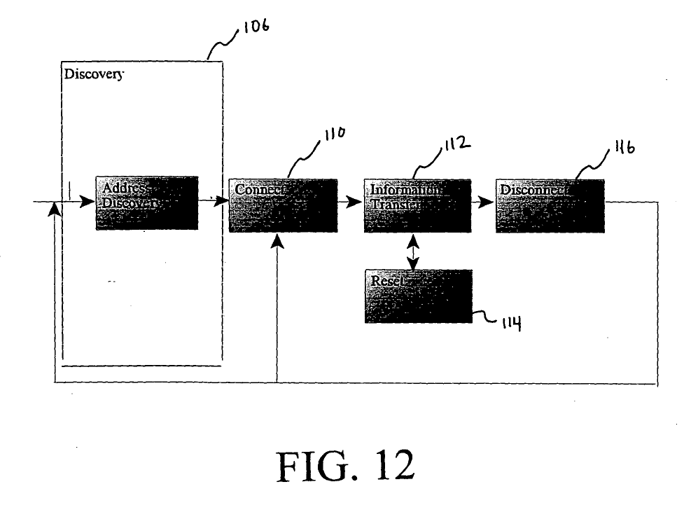

FIG. 12 illustrates an overview of the phases and procedure utilized to establish an Irda link and transfer information between a first infrared capable device and a second infrared capable device. In the following description, the optical interfacing unit 72 may be the first device and the wireless device 2 may be the second device, or vice versa. In a discovery phase 106 of the Irda connection, devices having Irda capabilities identify other devices having infrared capability within a communication range and exchange operating conditions. A connection phase 110 is utilized to establish an infrared Link Access Protocol (IrLAP) connection between the optical interfacing unit 72 and a wireless device 2. An information exchange phase 112 determines how IrLAP layers exchange information frames over an established IrLAP connection. A reset phase 114 is utilized to reset an established IrLAP connection and a disconnect phase 116 is utilized to terminate an established IrLAP connection.

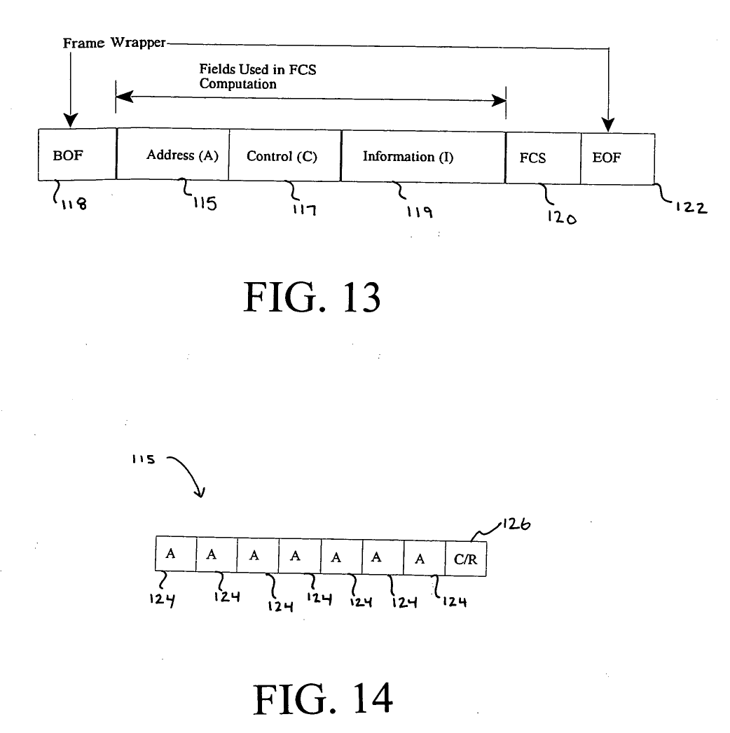

As noted above, the Irda protocol of the present invention utilizes a frame as the method for grouping all information for transmission over the Irda link. FIG. 13 illustrates the format of one embodiment of a frame 113 used in the present invention. Preferably, the frame format has a beginning of a frame (BOF) flag 118, a frame check sequence 120 using an address field 115, a control field 117, and a information field 119 in its computation, and a end of frame (EOF) flag 122.

At a first level of grouping, the frame 113 has two variables Ns and Nr in the control field 117 for allowing sequencing frames and checking for missing or duplicate frames. Ns identifies the sequence number of the transmitted frame and Nr identifies the sequence number for the next expected sequence frame. Preferably, the count capacity for Ns or Nr is 8, utilizing 7 through 0 where 7 wraps around to 0 for sequencing an unlimited number of frames. Although the dynamic infrared system 70 may transmit un-sequenced data, it is preferred that the dynamic infrared system 70 transmit sequenced frames when transferring information and use error checking procedures for missed or duplicated frames.

The address field 115 of the frame 113 is a connection address uniquely identifying a second station connected to a first station when in normal response mode. Preferably, the address field 115 is set to NULL (B′0000000) or Broadcast (B′1111111) by at least one station in a normal disconnect mode. When a connection is established, the first station allocates a random 7-bit value that does not conflict with an existing connection, and assigns it as the connection address. As shown in FIG. 14, the address field 115 comprises 7 address bits 124 and a command/response bit 126. Preferably, a ‘1’ in the command/response bit identifies the frame 113 as a command frame. Similarly, a ‘0’ in the command/response bit identifies the frame 113 as a response frame.

The control field 117 defines the function of the frame 113. Preferably, the control field has at least one of three formats including an unnumbered format, a supervisory format, or an information format. Generally, the unnumbered format is used for data link management including discovery, activating and initializing the second station, reporting procedural errors not recoverable by retransmission, and transferring data when the location of the data in a sequence of frames is not to be checked. The supervisory format assists in the transfer of information including acknowledging the received frames, conveying ready or busy conditions, and reporting frame sequencing errors. The information format provides for the transfer of information in the information field 119 including the Nr and Ns variable used to keep track of sequenced frames.

The frame 113 further includes the frame check sequence 120. The frame check sequence 120 is an error detection method for the frame 113 and utilizes the address field 115, the control field 117, and the information field 119 in its computation. Preferably, the field check sequence utilizes a CRC-16 algorithm.

As noted above, one of the phases in establishing an Irad link is the discovery phase 106. The discovery phase 106 includes a procedure for address discovery 108 in which the optical interfacing unit 72 determines wireless device 2 addresses within a communication range. Preferably, the dynamic infrared transfer system 70 utilizes an IrLAP Fast Connect Address discovery procedure. The IRLAP Fast Connect discovery procedure provides a faster method of establishing an infrared connection between two Irda devices within the communication range. The Fast Connect uses a 1-Slot discovery which assumes only one Irda device is within communication range of the initiating device. Preferably, the initiating device is the wireless device 2, however the optical interfacing unit 72 may be the initiating device. During the Fast Connect procedure, the initiator transmits a 1-Slot exchange identification (XID) command; the responder sends an XID response containing responders 32-bit device address and optional hint bits and at least one device name; and the initiator sends a final XID command with optional hit bits and device name. Preferably, the initiator transmits the 1-Slot XID command at a 115.2 K baud rate followed by a 25 ms listening period. The expected response is an XID response frame. The XID command/response frame includes discovery information whose content is specified by the service user layer. One embodiment of the frame content of the XID command and response is as follows:

| | | |
|---|---|---|
| BOF | | 1 Byte |
| Address | Address | 1 Byte |
| XID Command | Control | 1 Byte |
| or | | |
| Response | | |
| Source Address | Information | 4 Byte |
| Destination Address | | 4 Byte |
| Discovery Flag | | 1 Byte |
| Slot Number | | 1 Byte |
| Version Number | | 1 Byte |
| Discovery Info | | 32 Byte |
| FCS | | 2 Byte |
| EOF | | 1 Byte |

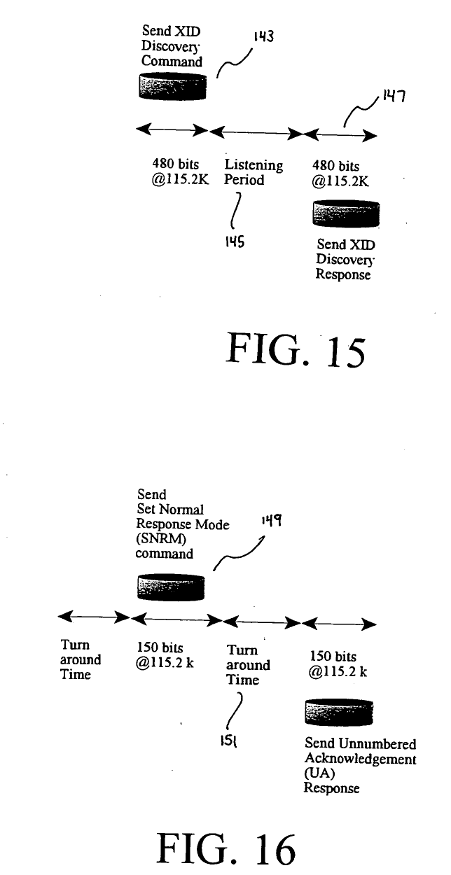

FIG. 15 illustrates a preferable estimated timing diagram for completing the discovery phase. As noted above, the wireless device transmits the 480 bit 1-Slot XID command at a 115.2 K baud rate 143. Preferably, the transmit time is 5 ms. This is followed by a 25 ms listening period 145. The expected response is an XID response frame taking 5 ms 147. Preferably, the total estimated time for address delivery is 35 ms.

The link procedure further includes the connection phase 110 to establish an infrared Link Access Protocol (IRLAP) connection between the first infrared capable device and the second infrared capable device. The first infrared capable device and/or the second infrared capable device may actively attempt to establish a connection by sending a Send Set Normal Response Mode (SNRM) frame comprising fields indicating connection parameters that can be supported by the sender of the SNRM frame. An example of the contents of the SNRM command frame is shown below:

| | | |
|---|---|---|
| BOF | | 1 Byte |
| Address | Address | 1 Byte |
| SNRM Command | Control | 1 Byte |
| Source Address | Information | 4 Byte |
| Destination Address | | 4 Byte |
| Connection Address | | 1 Byte |
| Negotiation Parameters | | N Byte |
| FCS | | 2 Byte |
| EOF | | 1 Byte |

Upon receipt of the SNRM frame, the receiving device determines whether it will accept or refuse the attempted connection. If the receiving device accepts the connection, the receiving device utilizes a negotiation procedure to determine a set of mutually acceptable connection parameters and transmits an Unnumbered Acknowledgement (UA) frame accepting the connection and indicating the parameters. If the receiving device decides to refuse the connection attempt, the receiving device returns a Disconnect Mode (DM) frame. An example of the contents of a UA response frame is shown below:

| | | |
|---|---|---|
| BOF | | 1 Byte |
| Address | Address | 1 Byte |
| Unnumbered | Control | 1 Byte |
| Acknowledgement (UA) | | |
| Response | | |
| Source Address | Information | 4 Byte |
| Destination Address | | 4 Byte |
| Negotiation Parameters | | N Byte |
| FCS | | 2 Byte |
| EOF | | 1 Byte |

The SNRM command and UA response frames include a negotiation parameters field used to pass connection parameters to each other that both devices can agree upon. In the dynamic infrared transfer system 70, the preferred parameters may be set as defaults and thus are not required to be passed or negotiated between the first infrared capable device and the second infrared capable device. The preferred parameters are as follows:

| Baud Rate | 115.2 | kbps |
|---|---|---|
| Max Turn Around Time | 100 | ms |
| Data Size | 1024 | byte |
| Window Size | 1 | |
| Additional BFOs | 0 | |
| Minimum Turn Around Time | 5 | ms |
| Link Disconnect | 12 | seconds |

The connection may be set up such that coupon data may be split into large information frames when sent from the wireless device 2 to the optical interfacing unit 72. For each frame received at the optical interfacing unit 72, the optical interfacing unit 72 may transmit an acknowledgement back to the wireless device 2. The acknowledgement releases the frame and allows for it to be pipelined through the optical interfacing unit 72 to the point of sale terminal 74.

An illustration of the preferred estimated time to complete the Irda connection is shown in FIG. 16. Preferably, the 150-bit SNRM frame is transmitted at 115.2 kbps with a transmit time of 2 ms 149. This is followed by the turn around time in which the receiving device determines whether it will accept or refuse the attempted connection. The preferable turn around time is 10 ms 151. In the event the receiving device accepts the connection, the receiving device transmits the 150-bit UA frame at 115.2 kbps with a preferable transmission time of 2 ms 153. Preferably, the total time for connection establishment is 14 ms.

As noted, the link procedure further includes an information exchange phase 112 to govern information exchange among IRLAP layers during the connection. After having sent the UA response in response to an SNRM command frame or having received the UA response frame to a sent SNRM frame, the IRLAP layer may accept and send unnumbered information (UI) frames, information format and supervisory format frames. One embodiment of the information format is as follows

| | | |
|---|---|---|
| BOF | | 1 Byte |
| Address | Address | 1 Byte |
| Information Format | Control | 1 Byte |
| Payload | Information | N Bytes |
| | | (898 Bytes for a |
| | | coupon data format) |
| FCS | | 2 Byte |
| EOF | | 1 Byte |

The Ns and Nr fields for checking frames are in the control field 117. An embodiment of the supervisory ready receive frame is shown below:

| | | |
|---|---|---|
| BOF | | 1 Byte |
| Address | Address | 1 Byte |
| Supervisory | Control | 1 Byte |
| Receive Ready (RR) | | |
| Response | | |
| FCS | | 2 Byte |
| EOF | | 1 Byte |

The link procedure may permit up to 7 frames to be sent before the responder sends back a supervisory ready receive frame. Moreover, the responder may selectively request for any of the 7 frames to be re-transmitted. In the dynamic infrared transfer system 70, the information frames may be pipelined through the optical interfacing unit 72 to maximize throughput. In this case, the optical interfacing unit 72 can send a supervisory ready receive frame after each received information frame so that the data can be processed and transmitted to the point of sale terminal 74.

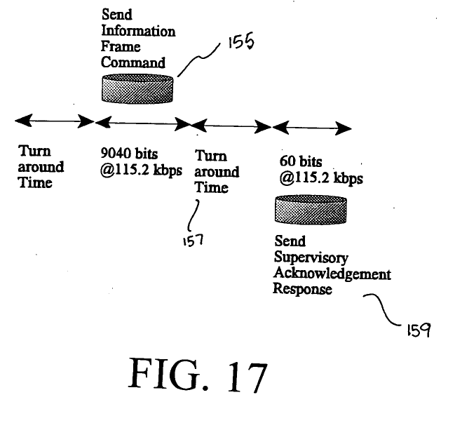

An illustration of the preferred estimated time for completing the Irda information phase is illustrated in FIG. 17. Preferably, the 9040-bit information frame is transmitted at 115.2 kbps with a transmission time of 79 ms 155. This is followed by a 10 ms turn around time 157. The 60-bit acknowledgement response is transmitted at 115.2 kbps with a transmission time of 1 ms 159.

The disconnect phase 116 of the link procedure closes an established connection. The reset phase 114 is utilized to reset the state of the established connection. The responsibility for unacknowledged information frames reverts to a user service layer when either a reset or a disconnect takes place.

As mentioned above, the dynamic infrared transfer system 70 provides for a coupon transaction or a financial transaction, initiated by either the wireless device 2 or the dynamic infrared transfer system 70. The dynamic infrared transfer system 70 may therefore transfer coupon, financial, or used coupon information frames. Preferably, the dynamic infrared transfer system 70 minimizes the payload content so as to maximize throughput from the wireless device 2 to the point of sale terminal 74. The preferable format for coupon data is as follows:

| Byte | | |
|---|---|---|
| Format | Format | Information |
| 0 | Frame Type (2 bits) (Coupon b'00) | Frame Header |
| | Frame Number (4 bits) | |
| 1 | Coupon Size | |
| 2 | Coupon #0, digit 0 | Frame Data |
| | Coupon #0, digit 1 | |
| 3 | Coupon #0, digit 2 | |
| | Coupon #0, digit 3 | |
| | ″ | |
| | ″ | |
| 8 | Coupon #0, digit 13 | |
| | Coupon #0, digit 14 | |
| | ″ | |
| | ″ | |
| 891 | Coupon #127, digit 0 | |
| | Coupon #127, digit 1 | |
| 892 | Coupon #127, digit 2 | |
| | Coupon #127, digit 3 | |
| | ″ | |
| | ″ | |
| 897 | Coupon #127, digit 13 | |
| | Coupon #127, digit 14 | |
| 898 | Last Coupon Indicator (b'1111) | |

The preferable format for used coupon data is:

| Byte Format | Format | Information |
|---|---|---|
| 0 | Frame Type (2 bits) (Coupon b'01) | Frame Header |
| | Coupon Frame Number (1 bit) | |
| | (“0” - first frame coupons 1-500, | |
| | “1” - second frame coupons 501-1000) | |
| 1 | Used Coupon Index #1 (7-0) | Frame Data |
| 2 | Used Coupon Index #2 (5-0), Used Coupons #1 (9-8) | |
| 3 | Used Coupon Index #3 (3-0), Used Coupons #2 (9-6) | |
| 4 | Used Coupon Index #4 (1-0), Used Coupons #3 (9-4) | |
| 5 | Used Coupon Index #5 (9-2) | |
| | ″ | |
| | ″ | |
| | Used Coupon Index #497 (7-0), | |
| | Used Coupon Index #498 (5-0), Used Coupons #497 (9-8) | |
| | Used Coupon Index #499 (3-0), Used Coupons #498 (9-6) | |
| | Used Coupon Index #500 (1-0), Used Coupons #499 (9-4) | |
| 650 | Used Coupon Index #500 (9-2) | |
| 651 | Last Used Coupon Indicator (b'1111111000) | |

Finally, the preferable format for credit card financial data is:

| Frame Number | Format | Information |
|---|---|---|
| 0 | Frame Type (2 bits) (Credit Card, b'11) | Frame Header |
| 1 | Card Name, Byte 0 | Frame Data |
| 2 | Card Name, Byte 1 | |
| 3 | Card Name, Byte 2 | |
| 4 | Card Name, Byte 3 | |
| 5 | Card Number, Byte 0 | |
| | ″ | |
| | ″ | |
| 24 | Card Number, Byte 19 | |
| 25 | Card Expiration Date, Byte 0 | |
| 26 | Card Expiration Date, Byte 1 | |
| 27 | Card Expiration Date, Byte 2 | |
| 28 | Card Expiration Date, Byte 3 | |

The frame header for coupon data information includes a frame type, frame number, and coupon size. The frame type identifies the frame. As seen above, the three types of frames in the dynamic infrared transfer system 70 are coupon (b′00), used coupon (b′01), and credit card (b′10). The frame number is utilized to calculate and monitor a coupon index. Preferably, a list of coupons is indexed, thus no encryption or decryption is required. A coupon index is passed from the point of sale terminal 74 after determining the list of coupons used in the transaction. The coupon size is the number of digits in the stock keeping unit of the coupon. If the coupon size has a value, then all the coupons in the frame are of that length. If the coupon size is zero, the coupon stock keeping units are of variable length. In the event the coupon size is zero, the individual coupons are separated by a b′1010 (A). The coupon data frame shown above has a maximum coupon size of 14 digits, however any length may be used.

The following description specifies one preferred embodiment of the timing between the processor 96, the UART infrared interface 104, and the Irda transceiver 100. The processor 96 generates the Irda frames and passes the frames through the UART infrared interface 104 to the Irda transceiver 100. The Irda transceiver encodes/decodes the UART information for transmission via external LED circuitry.

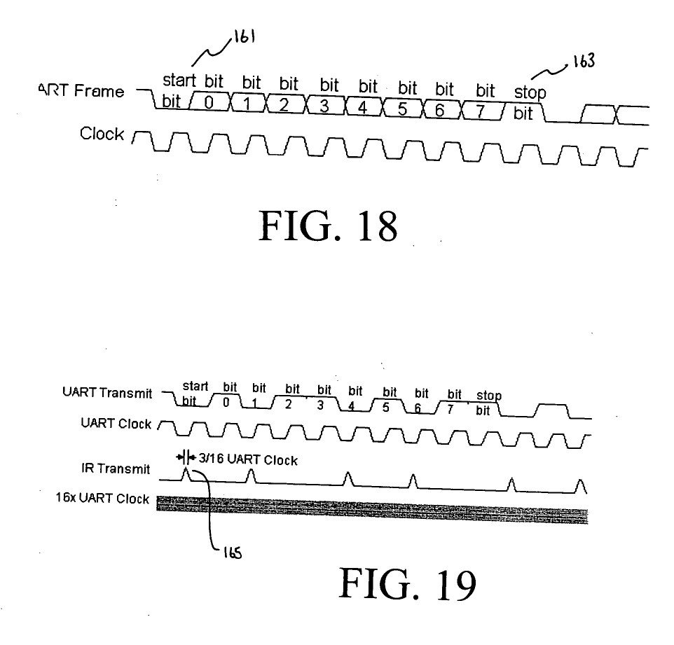

The UART infrared interface 104 transmits a single byte at a time wrapped in a “start” pulse signal 161 and “stop” pulse signal 163 as illustrated in FIG. 18. Preferably, a “start” pulse is indicated by logic 0 and a “stop” pulse is indicated by logic 1. The UART infrared interface 104 in the dynamic infrared transfer system 70 may utilize 8 bits with no parity. The “clock” may be set to the desired baud rate. In transmit mode, the Irda encoder generates a pulse equal to 3/16 the baud rate 165. When the information from the UART infrared interface 104 is a logic ‘0’, the Irda encoder transmits a ‘1’. When the information from the UART infrared interface 104 is a logic ‘1’, the Irda encoder transmits a ‘0’ as illustrated in FIG. 19. In the receive mode, the Irda encoder/decoder generates a pulse to the UART infrared interface equal to the baud rate. When the information from the IR is a high pulse, the Irda decoder generates a logic ‘0’, otherwise the decoder generates a logic ‘1’.

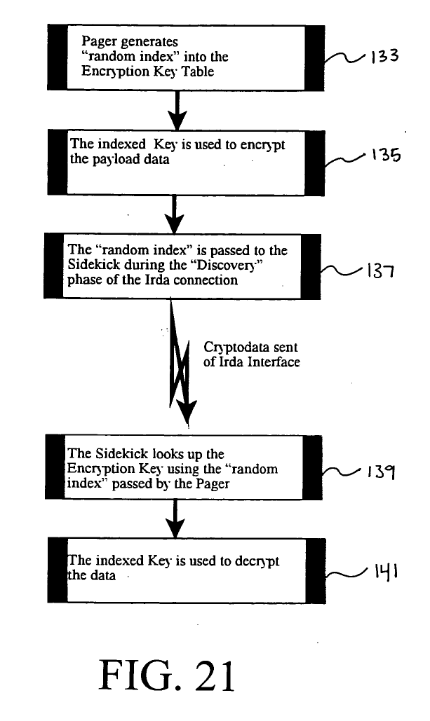

Preferably, the dynamic infrared transfer system 70 employs data encryption of the coupon and credit card data in the Irda information frames. The dynamic infrared transfer system 70 may utilize a symmetric encryption method to secure the data between the wireless device 2 and the optical interfacing unit 72. In one embodiment, the wireless device 2 and sidekick 72 store a list of 32 different encryption keys wherein the list is identical for the wireless device 2 and the sidekick 72. With reference to FIG. 21, the wireless device 2 generates a random index into the list at the beginning of every new transaction 133. The encryption key index is utilized to encrypt the data 135 transmitted between the wireless device 2 and the optical interfacing unit 72. The wireless device 2 passes the randomly generated index to the sidekick 72 during the initial phases of the Irda connection 137. The optical interfacing unit 72 identifies 139 which encryption key to utilize using the random index passed by the wireless device 2. The sidekick 72 then uses an indexed key to decrypt the data 141.

Preferably, the CAST-128 algorithm as specified in RFC 2144, herein incorporated by reference, is utilized. The CAST-128 algorithm is a symmetric algorithm that may be implemented with different key lengths. The RFC 2144 suggests using a 40-bit encryption key, however any length may be used. The CAST-128 algorithm utilizes 8 Kbyte of RAM to store 8 substitution tables that are used in the algorithm. A summary of the CAST-128 algorithm is described below.

INPUTS:

A 64-bit block of plaintext (given as m1 . . . m64)

A encryption Key (given a 40-bit key, given as k1 . . . K40)

OUTPUTS:

The encrypted ciphertext (given as c1 . . . c64)

STEPS:

1. Compute 12 pairs of subkeys {Km(i), Kr(i)} from the encryption Key (k1 . . . K40) by performing a table lookup into a substitution box and performing a number of XOR operations, as explained in RFC 2144.

2. Split the plaintext into left and right 32-bit halves 1(0)=m1 . . . m32 and R(0)=m33 . . . m64.

3. Compute L(i) and R(i) for 1 to 12. The plaintext data is taken through 12 rounds of calculations involving combining the data with the computed subkeys and using this calculation in a function that performs a table lookup, XOR, plus and minus operations to get the next L(i) and R(i)

L(i)=R(i−1)

R(i)=L(i−1)\hat{ }f(R(i−1), Km(i), Kr(i))

Where F( ) is a function defined as one of the three types described below.

4. Concatenate the final L(12) and R(12) to form the final output c1 . . . c64.

Three different round functions may be used in the CAST-128. The rounds are:

TYPE 1: I=((Km(i)+D)<<<K(i))

F=((S1[Ia]\hat{ }S2[Ib])−S3[Ic])+S4[Id]

TYPE 2: I=((Km(i)\hat{ }D)<<<K(i))

F=((S1[Ia]−S2[Ib])+S3[Ic])\hat{ }S4[Id]

TYPE 3: I=((Km(i)−D)<<<K(i))

F=((S1[Ia]+S2[Ib])\hat{ }S3[Ic])−S4[Id]

Where:

“D” is the data input to the function (F),

“Ia−Id” are the most significant byte through the least significant byte of I, respectively,

S1 to S4 are lookup tables for data substitution,

+ and − are addition and subtraction modulo 2**32,

“\hat{ }” is bitwise XOR, and

“<<<” is a circular left-shift operation

Preferably, rounds 1, 4, 7, 10 use function (F) type 1. Rounds 2, 5, 8, 11, use function (F) type 2. Rounds 3, 6, 9, 12 use function (F) type 3.

In one embodiment of the present invention, the dynamic infrared transfer system 70 may perform a coupon transaction. As mentioned above, the wireless device 2 includes a Coupon Channel 128 having coupon data that can be accessed similar to accessing advertising messages in the Maildrop Message Channel via the main menu 33. The addition of the coupon enhancement will add a coupon capcode to the menu selection. As a result, one embodiment of the modification capcodes and menu selections of the present invention is illustrated below:

| Capcode | Menu Option |
|---|---|
| 1 | Primary |
| 2 | Main Maildrop |
| 3 | News |
| 4 | Sport |
| 5 | Info 1 |
| 6 | Info 2 |
| 7 | Info 3 |
| 8 | Info 4 |
| 9 | Info 5 |
| 10 | |
| 11 | |
| 12 | |
| 13 | |
| 14 | Coupon |
| 15 | Graphic |
| 16 | Graphic |

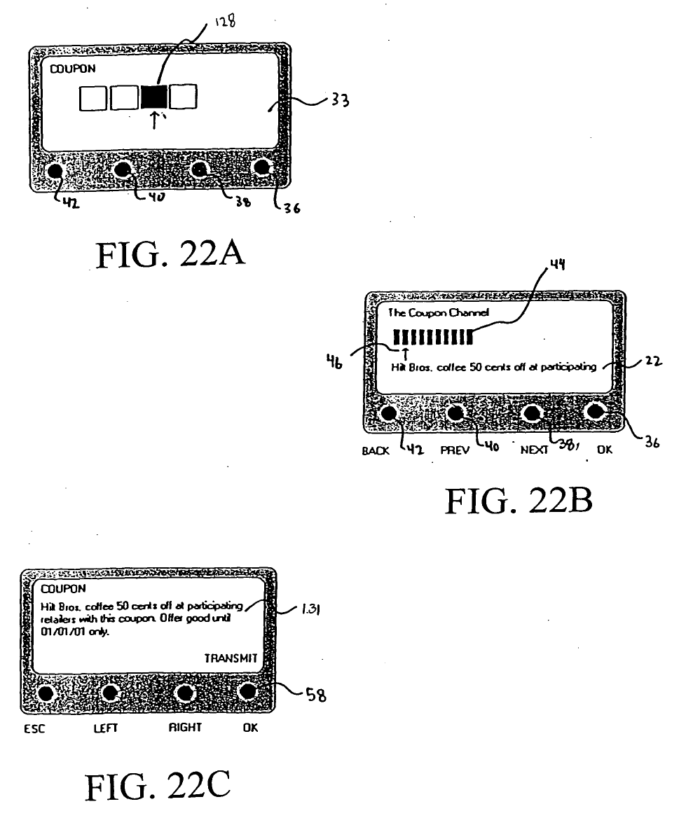

The Coupon Channel 128 receives the coupons in a manner similar to the advertising messages received by the Maildrop Folder 48. Thus, the Coupon Channel 128 can receive coupon data via electromagnetic transmission such as, RF transmission or IRDA reception. The received coupon data is stored in a coupon memory 130 and is accessed via the interface through the Coupon Channel 128 as seen in FIG. 22A. Selecting the Coupon Channel 128 opens a new menu screen presenting a plurality of coupons messages stored in the Coupon Channel 128 as seen in FIG. 22B. Using the “NEXT” button 38 and the “PREV” button 40, the user can navigate the cursor 46 through the full range of indicators 44. To assist the user in selecting coupon, the screen additionally displays, below the indicators 44, a single line of text 22 detailing the beginning of the relevant coupon indicated. This allows the user to glance at the first part of the coupon stored in the Coupon memory 130 and scroll from slot to slot to find a selected coupon of interest. Depressing the “OK” button 36 allows the user to display the selected coupon on the display 6, as seen in FIG. 22C.

FIG. 22C shows a selected coupon 131 stored in the coupon memory 130 being displayed on the display 6 of the wireless device 2. Upon the selected coupon 131 being displayed, the functionality of the “NEXT” button 38 and “PREV” button 40 change so that depressing the “NEXT” button 38 moves the display screen forward so as to show subsequent screens of the coupon. When the end of the current coupon 81 is reached, a depression of the “NEXT” button 38 displays the first screen of the next coupon in that direction. Similarly, depressing the “PREV” button 40 moves the display screen backwards in the current coupon 131 until the beginning of the current coupon 131. When the beginning of the current coupon 131 is reached, depressing “PREV” button 40 will display the first screen of the coupon in the previous direction. Depressing the “BACK” button 42 moves the user up a level in the menu system as seen in FIG. 22B, thus allowing navigation through the full range of coupons and selection of individual coupons to be viewed.

FIG. 22C illustrates a coupon 131 displayed on the display 6. At the point of sale terminal 86, a depression of the “OK” button 58 to activates the transmitter module 88 of the dynamic infrared transfer system 70. The IC chip 80 copies the selected coupon from the coupon memory 130 to the IC memory and configures the data for infrared transmission. The IC chip 80 sends a signal comprising the configured selected coupon data and the pager's identity to the IR LED 92 for transmission to the sidekick 72.

Upon receiving the signal, the optical interfacing unit 72 decodes and transmits the decoded data to the point of sale terminal 74. Further, the optical interfacing unit 72 may send a signal comprising a confirmation of receipt to the IR LED 92 for transmission of the confirmation of receipt to the wireless device 2. In the event of a bad transmission from the wireless device 2 to the optical interfacing unit 72, the optical interfacing unit 72 may send a signal requesting retransmission of the signal comprising the coupon data.

During operation, the point of sale terminal 74 receives the coupon data in the manner described above and buffers the coupon data in a point of sale memory. The point of sale system 74 utilizes coupon data to apply the relevant merchandise discount to the user's purchases. The point of sale system takes feedback in order to determine the used coupons.

Preferably, the feedback interception occurs in the datastream between a scanning device and the processor when the data is in the form of a stock keeping unit (SKU). The SKU is an identification, usually alphanumeric, of a particular product that allows it to be tracked for inventory purposes. In the case of a manufacturer's coupons, the SKUs are supplied by a manufacturer to both the wireless device service provider and/or the wireless device 2 and the merchant. In the case of a merchant specific coupon, the merchant supplies the SKU's to the wireless device service provider and/or the wireless device 2.

Once the scanning of all purchased products is complete and the relevant coupons are applied, the feedback interception may begin. At this point, a dataset comprising the coupons applied to the transaction is created by the point of sale system 74. The point of sale system 74 deletes the applied coupons from the buffered dataset and the point of sale system 74 transmits the abbreviated dataset to the optical interfacing unit. The wireless device 2 receives the abbreviated dataset and overwrites the previous dataset stored in the coupon memory 130.

Additionally, it is possible that the point of sale terminal 74 transmits the applied coupon dataset to the optical interfacing unit 72 which deletes the used coupons from the buffered dataset.

By utilizing SKU's, the burden of corresponding coupons to items lies with the merchant system. Coupon SKU maintenance is required for conventional paper coupons, thus the burden of corresponding coupons to items does not additionally encumber the merchant system.

In an even further embodiment, the point of sale terminal includes a RF receiver (not shown) for receiving verification information for a plurality of wireless devices 2. The verification information is stored in a memory 98. Upon receiving the signal comprising the configured selected coupon data and the wireless device's identity transmitted by the wireless device 2, the processor 82 compares the information comprising the signal with the corresponding verification data to authenticate the transaction.

In a further embodiment of the present invention, the user does not have to select a coupon to send. Rather, all of the coupons are transmitted. After check-out, the user activates a coupon transfer by selecting the coupon channel from the main menu 33, in the method described above. The wireless device 2 transmits coupon data comprising all the coupons in the coupon memory 130 to the sidekick 72 via the Irda interface 76. Preferably, the list of valid coupons and all radio frequency functions are disabled until completion of the coupon transaction. The wireless device 2 and the optical interfacing unit 72 may have an indicator indicating the coupon transaction is in progress. The indicator may be audio, such as a tone, or visual, such as a blinking light.

The optical interfacing unit 72 receives the coupon data from the wireless device via the Irda transceiver 100 and stores the received coupon data in memory 98. The coupon data stored in memory is transmitted to the point of sale terminal 74 via the UART interface 102. The point of sale terminal 74 compares the received coupon data with the purchased items and generates a list of used coupons. It is also possible for the point of sale terminal to compare the received coupon information with recognized coupon information that is relevant to different products that are eligible for a discount. In this manner, accepted coupon information comprising received coupons matching recognized coupons is applied to the transaction. This list of used coupons is transmitted to the optical interfacing unit 72. The optical interfacing unit 72 transmits the list of used coupons to the wireless device 2 via the infrared transceiver 100. The wireless device 2 transmits a confirmation message to the point of sale terminal 74, via the optical interfacing unit 72 to complete the transaction. In the event the wireless device 2 and optical interfacing unit 72 have indicators, the indicators will indicate the transaction is complete. This may be accomplished by the audio and/or visual indicator being turned off. The wireless device 2 may re-enable the unused coupons from the valid coupon list and re-enable the wireless device's radio frequency functions.

Preferably, the dynamic infrared transfer system 70 may transmit up to 1000 coupons from the wireless device 2 to the optical interfacing unit 72. This process may take less than 3.5 seconds to complete. Once the user initiates the transaction with the wireless device 2, the user may release the button used to initiate the transaction. However, a line-of-sight will be needed to be maintained between the wireless device 2 and the optical interfacing unit 72 during the 3.5 seconds or until the coupon transaction is complete.

In the event that a plurality of identical stock keeping units are present, the point of sale system 74 may determine the number of identical stock keeping units used based on the purchase and transmit to the wireless device 2 a set of used stock keeping units. The used stock keeping units are removed from memory 84 and the remainder of the identical stock keeping units are available for a future transaction.

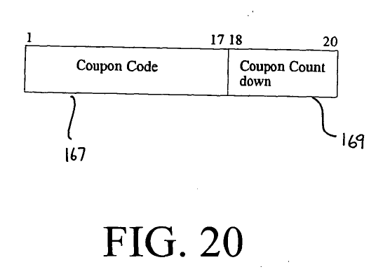

Preferably, the coupon stock keeping unit data is a 20 byte field as illustrated in FIG. 20. The first 17 bytes 167 are the coupon code. The dynamic infrared transfer system 70 may ignore the leading zeros in the coupon code because the leading zeros may be utilized as padstrings to accommodate different length codes. The last 3 bytes 169 represent the count down period or the lifetime in a 24 hour period that a coupon stock keeping unit remains valid. Each 24 period, the wireless device 2 may decrement the count down by a period of 1. Once the count reaches 0, the wireless device 2 may delete the stock keeping unit and remove it from memory.

If communication fails over the Irda link during the process, the indicator may indicate the failure. This may be accomplished, for example, through the use of a red blinking light. Preferably, the Irda link is connected for a short time period after an error indication such that the error can be corrected. It is preferred that the short time period is three seconds. In the event the error is due to the wireless device 2 not being optically pointed to the optical interfacing unit 72, the short time period will enable the user to adjust the wireless device 2. If the Irda link cannot recover within the short time period after the error, the link may be disconnected and the user will be required to re-initiate the transaction.

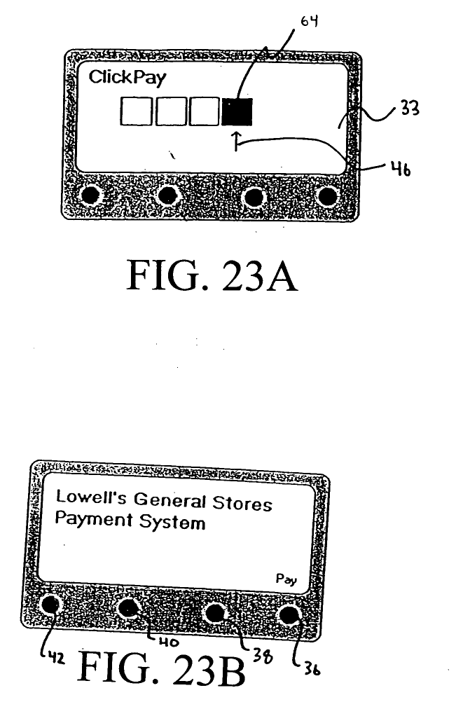

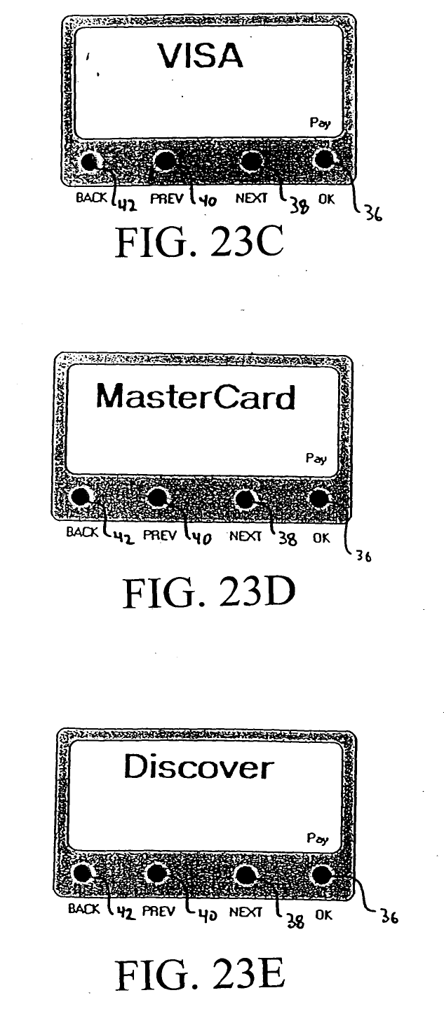

In another embodiment of the present invention, the dynamic infrared transfer system 70 may be utilized to conduct a financial transaction. FIGS. 23A-23E illustrate the wireless device 2 and the dynamic infrared transfer system 70 therein to present a payment, such as a credit card or a debit card, to a point of sale terminal 74.

The pager includes a Payment Channel 64 having payment information that can be accessed similar to the coupons in the Coupon Channel 128 via the main menu 33. FIG. 23B illustrates a user utilizing a selected merchant's credit card, such as Lowell's General Stores Payment System. FIGS. 23C-23E illustrates a user utilizing the wireless device 2 in the multiple payment system configuration. Selecting the Payment Channel 64 opens a new menu screen displaying a payment option, such as a VISA credit card payment, stored in the memory 84, as seen in FIG. 23C. Using the “NEXT” button 38 and the “PREV” button 40, the user can navigate through the full range of payment options stored in the memory 84. The full range of payment options may include a MasterCard credit card and/or Discover credit card as seen in FIGS. 23D and 23E.

Preferably, the credit card data is stored in an ASCII data string comprising the payment card data commonly encrypted in the magnetic stripe of a standard credit card. In one embodiment, the credit card data is entered and stored in the wireless device by the user. The user enters the card number and establishes a dynamic infrared transfer system personal identification number (PIN). The dynamic infrared transfer system personal identification number may be independent of any credit card personal identification number. The dynamic infrared transfer system personal identification number is used for security of the credit card information on the wireless device 2.

The wireless device 2 may have a card setup menu item to configure credit card information. The card setup menu item may be selected from the payment channel 164 via the main menu 33. When the card setup menu item is selected for a first time, the user is presented with a PIN setup screen. Preferably, this is a four character numerical field presented in the following manner:

____ Enter PIN

____ Confirm PIN

The user may input alphanumeric characters as the personal identification number, however it is preferable that only numbers be utilized. Once the user enters the personal identification number, the wireless device 2 ensures that the “Enter PIN” and the “Confirm PIN” entries are identical. If so, the wireless device 2 stores the personal identification number in memory 84 for future identification of the authorized user. In the event that the “Enter PIN” and “Confirm PIN” are not identical, the wireless device 2 may request the user to reenter the personal identification number or may terminate the card setup.

Upon accepting the personal identification number, the pin setup may be permanently deleted from the memory 84 of the wireless device 2 so as to prevent fraudulent transactions by an unauthorized user. Without the dynamic infrared transfer system personal identification number, the wireless device 2 will be unable to communicate with the optical interfacing unit 72.

To setup the remaining credit card information, the wireless device 2 may require the user to enter and confirm the dynamic infrared transfer system personal identification number. The user will be presented with a screen similar to the following in order to complete the credit card setup:

Setup #1

Card Name: ____

Card #: ____ ____ ____ ____

Card Expiration Date: __/__

When the user shops at a merchant utilizing the dynamic infrared transfer system, the user presents the dynamic infrared transfer system 70 enabled wireless device 2 to the optical interfacing unit 72. The payment information is stored in the memory 84 and is accessed via the interface as the Payment Channel 64. Selecting the Payment Channel 64 opens a new menu screen presenting payment information as seen in FIG. 23B. Selecting the “OK” button 36 activates the transmitter module 88 of the dynamic infrared transfer system 70. The IC chip 80 copies the payment information from the memory 84 to the IC memory and configures the payment information for infrared transmission. The IC chip 80 sends a signal comprising the configured payment information and the pager's identity to the IR LED 92 for transmission to the optical interfacing unit 72. Further, the payment information stored in the memory 84 may comprise a selected amount. Upon transmission of the configured payment information, the IC chip 80 may deduct the payment amount from the selected amount in memory. In this manner, the wireless device 2 is similar to using a debit card.

Upon receiving the signal, the optical interfacing unit 72 decodes the signal and transmits the decoded data to the point of sale terminal 74. Further, the optical interfacing unit 72 may send a signal comprising a confirmation of receipt to the IR LED 92 for transmission of the confirmation of receipt to the wireless device 2. In the event of a bad transmission from the wireless device 2 to the optical interfacing unit 72, the optical interfacing unit 72 may send a signal requesting retransmission of the signal comprising the financial data.

Upon receiving the financial data, the point of sale terminal 74 processes the credit card data. The point of sale terminal 74 accesses credit card systems through a modem, or any method as known by one of ordinary skill in the art. In a further embodiment, the point of sale terminal 74 may require the user to enter the personal identification number in order to verify the transaction.

In a further embodiment, the payment amount applied to the transaction is transmitted from the point of sale terminal 74 to the optical interfacing unit 72. Upon receiving the payment amount data, the optical interfacing unit configures the data for optical transmission to the wireless device 2 via the IR LED 92. The wireless device 2 receives the payment amount data from the optical interfacing unit 72 and stores the data in a transaction register memory. The register memory may be a separate memory unit or may be a data block in the memory 84 of the wireless device 2.

The transaction register memory may be similar to a transaction register utilized in a standard paper checkbook register. The transaction register may store data similar to information stored in the standard paper checkbook register such as the payment amount, the transaction date, a description of the transaction, and a balance of an account. Further, the transaction register may be password protected. Preferably, the password is the same as the PIN number, however, a different password may be utilized.

### Access Control System

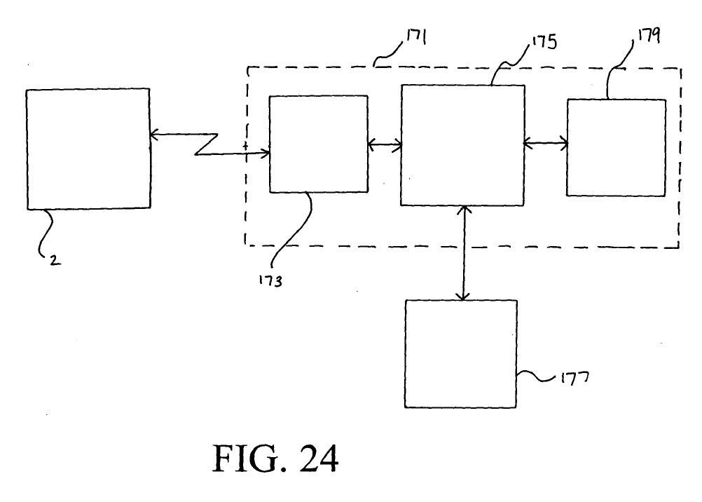

It should be noted that the wireless device 2 having the dynamic infrared transfer system 70 can be utilized in a plurality of additional scenarios. In one embodiment of the present invention, the wireless device 2 having the dynamic infrared transfer system 70 can be used in an access control system 171 as an electronic key, as seen in FIG. 24. Standard access enable/denial systems, as known by one of ordinary skill in the art, can be enhanced by the addition of the access control system 110 so as to permit communication with the wireless device 2 having an infrared transceiver 76. The access control system 171 may be added to any device that requires authorization to access.

In the present embodiment, the wireless device 2 would include an Identification Channel having the user's identification data stored in memory 84. The Identification Channel is accessed in a manner similar to the Coupon Channel 128, via the main menu 33. The wireless device 2 transmits the identification data via the transmitter module of the transceiver 76. The IC chip 94 copies the identification data from the memory 84 to the on-chip memory 88 and configures the identification data for infrared transmission. The IC chip 84 sends a signal comprising the configured identification data to the IR LED 92 for transmission to the access control system 171.

The access control system 171 of FIG. 24 includes an IRLED 173 capable of receiving and transmitting infrared signals and an IC chip 175 connecting the IRLED 173 to an access controlled device 177. The IRLED 173 receives the signal comprising the configured identification data transmitted by the wireless device 2 and transmits the signal to the IC chip 175. The IC chip 175 may send a signal comprising a confirmation of receipt to the IRLED 173 for transmission of the confirmation of receipt to the wireless device 2. Upon receiving the signal comprising the configured identification data, the IC chip 175 transmits the received data to an access database 179 and decodes the infrared signal to the access control system can utilize the identification data to enable or disable access to access controlled device 177. The access control device 177 may be any device that requires authorization to access, such as computer equipment requiring a login, vehicles, and hazardous or private areas where it is desirable to deny access to unauthorized users, such as a home.

In an even further embodiment of the present invention, the identification data stored in the memory 84 is utilized to track a user's usage of a resource, such as a library, or attendance, such as in a classroom setting. The system would be enabled in a manner similar to the access control access system 171.

### Voicemail System

With reference to FIG. 25, a further embodiment, the present invention includes a method for providing advertising to a sender 32 of a page to the wireless device 2. The plurality of wireless devices 2 is provided to an advertiser 34 who may want to advertise to a sender 32 of a page to one of a plurality of wireless devices 2. A request is received from the advertiser 34 for placement of an audible advertising message on a voice mail system 30. Confirmation of receipt of the request is transmitted back to the advertiser. The request may direct that the audible advertising message be provided to sender 32 of a page and/or to a sub-set of users of the wireless devices 2. The audible advertising message is provided to the sender 32 of the page in response to the sender 32 of the page requesting to leave a voice mail message directed specifically to the identity of the wireless device 2. The advertising message may be provided to the sender 32 of the page prior to leaving the voice mail message. Paging service is provided to the wireless device 2 having the specified identity for notifying the user of the voice mail message wherein the user calls the voice mail system to hear the voice mail message directed specifically to the identity of the wireless device 2 of said user. The audible advertising message is provided to the user prior to hearing the voice mail message.

When the request for placement indicates that an audible advertising message is to be provided to sub-set of wireless devices 2, the request comprises demographic criteria. The identities of the sub-set are determined wherein the identities have user demographic information corresponding to the demographic criteria received from the advertiser 34. The demographic criteria may be age, gender, and/or profession. The paging service is provided to the wireless devices 2 such that the wireless devices 2 of the sub-set receive a page signal directed specifically to the identity of the wireless device 2 for notifying a user of a voice mail message wherein the user calls the voice mail system 30 to hear the voice mail message directed specifically to the identity of the wireless device 2. The audible advertising message is provided to the user prior to hearing the voice mail message.

### Website Banner

In a further embodiment, the present invention is a method of providing advertising to a sender of a page to a user of a wireless device 2. A website is provided to a sender for sending a page to a user of a wireless device 2. The website comprises a field for identifying the identity of the wireless device and a field for identifying the message. A request is received from the advertiser 34 for placement of advertising indicia through the website. Confirmation of receipt of the request is transmitted back to the advertiser. The advertising indicia are displayed in response to the sender sending the page message.

While the specific embodiments have been illustrated and described, numerous modifications come to mind without significantly departing from the spirit of the invention and the scope of protection is only limited by the scope of the accompanying claims.

What is claimed is:

1. A method for completing a commercial transaction utilizing a system having a point of sale terminal and a wireless device for transmitting commercial information to the point of sale terminal, the method comprising the steps of:
providing for receiving a first infrared signal from a wireless device for establishing communication with the wireless device without utilizing at least one infrared standard procedure;
providing for receiving a second infrared signal comprising the commercial information; and,
providing for processing the second infrared signal.

2. The method of claim 1 wherein the at least one infrared standard procedure comprises at least one of an address conflict resolution procedure and a sniff-open procedure.

3. The method of claim 1 wherein the point of sale terminal comprises an optical interface unit, the optical interface unit receiving the first and second infrared signals.

4. The method of claim 1 wherein the system further comprises an optical interface unit for communicating the commercial information to the point of sale terminal.

5. The method of claim 1 wherein the step of establishing communication comprises at least one of a discovery procedure and a connection procedure.

6. The method of claim 1 wherein the step of receiving the second infrared signal comprises an information exchange procedure.

7. The method of claim 5 wherein the discovery procedure comprises an IrLAP Fast Connect Address discovery procedure.

8. The method of claim 1 wherein the at least one infrared standard procedure comprises at least one of an address conflict resolution procedure and a sniff-open procedure.

9. The method of claim 1 further comprising the step of completing the commercial transaction.

10. The method of claim 1 wherein the commercial information comprises coupon information.

11. The method of claim 10 wherein the coupon information comprises stock keeping unit (SKU) data.

12. The method of claim 10 further comprising the steps of:
providing for storing the coupon information as received coupon information;
providing for comparing the received coupon information with recognized coupon information; and,
providing for creating accepted coupon information comprising the received coupon information that matches with the recognized coupon information.

13. The method of claim 12 further comprising the steps of:
providing for applying the accepted coupon information to the commercial transaction;
providing for creating remaining coupon information comprising the received coupon information minus the accepted coupon information; and,
providing for transmitting the remaining coupon information to the wireless device.

14. The method of claim 12 further comprising a step of transmitting the accepted coupon information to the wireless device.

15. The method of claim 1 further comprising the steps of securing the commercial information, the method comprising the steps of:
providing for receiving a random key index;
providing for identifying an encryption key corresponding to the random key index; and
providing for decrypting the commercial information utilizing the encryption key.

16. The method of claim 1 wherein the commercial information comprises at least one of a credit card data and a debit card data.

17. The method of claim 1 further comprising the step of providing for receiving a personal identification number corresponding to the commercial information.

18. A method for completing a commercial transaction utilizing a system having a point of sale terminal and a wireless device for transmitting coupon information to the point of sale terminal, the method comprising the steps of:
providing for receiving an infrared signal comprising the coupon information;
providing for storing the coupon information as received coupon information; and,
providing for comparing the received coupon information with recognized coupon information.

19. The method of claim 18 further comprising the step of providing for creating accepted coupon information comprising the received coupon information that matches with the recognized coupon information.

20. The method of claim 19 further comprising the steps of:
providing for applying the accepted coupon information to the commercial transaction;
providing for creating remaining coupon information comprising the received coupon information minus the accepted coupon information; and,
providing for transmitting the remaining coupon information to the wireless device.

21. The method of claim 19 further comprising a step of transmitting the accepted coupon information to the wireless device.

22. The method of claim 18 further comprising the step of providing for receiving a first infrared signal from a wireless device for establishing communication with the wireless device without utilizing at least one infrared standard procedure, wherein the step of providing for receiving an infrared signal comprising the coupon information comprises providing for receiving a second infrared signal comprising the coupon information.

23. The method of claim 22 wherein the at least one infrared standard procedure comprises at least one of an address conflict resolution procedure and a sniff-open procedure.

24. The method of claim 22 wherein the step of establishing communication comprises at least one of a discovery procedure and a connection procedure.

25. The method of claim 24 wherein the discovery procedure comprises an IrLAP Fast Connect Address discovery procedure.

26. The method of claim 22 wherein the at least one infrared standard procedure comprises at least one of an address conflict resolution procedure and a sniff-open procedure.

27. The method of claim 18 wherein the point of sale terminal comprises an optical interface unit, the optical interface unit receiving the infrared signal.

28. The method of claim 18 wherein the system further comprises an optical interface unit for communicating the coupon information to the point of sale terminal.

29. The method of claim 18 wherein the step of receiving the infrared signal comprises an information exchange procedure.

30. The method of claim 18 wherein the coupon information comprises stock keeping unit (SKU) data.

31. The method of claim 18 further comprising the steps of securing the commercial information, the method comprising the steps of:
providing for receiving a random key index;
providing for identifying an encryption key corresponding to the random key index; and
providing for decrypting the commercial information utilizing the encryption key.

32. The method of claim 18 further comprising the step of providing for receiving a personal identification number corresponding to the commercial information.

33. A method for completing a commercial transaction utilizing a system having a point of sale terminal and a wireless device for transmitting commercial information to the point of sale terminal through infrared transmission, the method comprising the steps of:
providing for receiving a random key from a key index;
providing for identifying the random key; and,
providing for decrypting the commercial information utilizing the random key.

34. The method of claim 33 wherein the step of providing for identifying the random key comprises providing for identifying the random key from a second key index.

35. The method of claim 34 wherein the second key index is identical to the key index.

36. The method of claim 33 wherein the process of transmitting commercial information to the point of sale terminal comprises a plurality of uniquely encrypted individual infrared transmissions.

37. The method of claim 33 further comprising the steps of:
providing for receiving a first infrared signal from a wireless device for establishing communication with the wireless device without utilizing at least one infrared standard procedure;
providing for receiving a second infrared signal comprising the commercial information; and,
providing for processing the second infrared signal.

38. The method of claim 37 wherein the at least one infrared standard procedure comprises at least one of an address conflict resolution procedure and a sniff-open procedure.

39. The method of claim 37 wherein the point of sale terminal comprises an optical interface unit, the optical interface unit receiving the first and second infrared signals.

40. The method of claim 37 wherein the system further comprises an optical interface unit for communicating the commercial information to the point of sale terminal.

41. The method of claim 37 wherein the step of establishing communication comprises at least one of a discovery procedure and a connection procedure.

42. The method of claim 37 wherein the step of receiving the second infrared signal comprises an information exchange procedure.

43. The method of claim 41 wherein the discovery procedure comprises an IrLAP Fast Connect Address discovery procedure.

44. The method of claim 37 wherein the at least one infrared standard procedure comprises at least one of an address conflict resolution procedure and a sniff-open procedure.

45. The method of claim 37 further comprising the step of completing the commercial transaction.

46. The method of claim 37 wherein the commercial information comprises coupon information.

47. The method of claim 46 wherein the coupon information comprises stock keeping unit (SKU) data.

48. The method of claim 46 further comprising the steps of:
providing for storing the coupon information as received coupon information;
providing for comparing the received coupon information with recognized coupon information; and,
providing for creating accepted coupon information comprising the received coupon information that matches with the recognized coupon information.

49. The method of claim 48 further comprising the steps of:
providing for applying the accepted coupon information to the commercial transaction;
providing for creating remaining coupon information comprising the received coupon information minus the accepted coupon information; and,
providing for transmitting the remaining coupon information to the wireless device.

50. The method of claim 48 further comprising a step of transmitting the accepted coupon information to the wireless device.

51. A method for completing a commercial transaction utilizing a system having a point of sale terminal and a wireless device for transmitting coupon information to the point of sale terminal, the method comprising the steps of:
providing for receiving an electromagnetic signal comprising the coupon information;
providing for storing the coupon information as received coupon information; and,
providing for comparing the received coupon information with recognized coupon information.

52. The method of claim 51 further comprising the step of providing for creating accepted coupon information comprising the received coupon information that matches with the recognized coupon information.

53. The method of claim 52 further comprising the steps of:
providing for applying the accepted coupon information to the commercial transaction;
providing for creating remaining coupon information comprising the received coupon information minus the accepted coupon information; and,
providing for transmitting the remaining coupon information to the wireless device.

54. The method of claim 52 further comprising a step of transmitting the accepted coupon information to the wireless device.

55. The method of claim 51 wherein the electromagnetic signal is an infrared signal.

56. The method of claim 55 further comprising the step of providing for receiving a first infrared signal from a wireless device for establishing communication with the wireless device without utilizing at least one infrared standard procedure, wherein the step of providing for receiving an infrared signal comprising the coupon information comprises providing for receiving a second infrared signal comprising the coupon information.

57. The method of claim 56 wherein the at least one infrared standard procedure comprises at least one of an address conflict resolution procedure and a sniff-open procedure.

58. The method of claim 56 wherein the step of establishing communication comprises at least one of a discovery procedure and a connection procedure.

59. The method of claim 58 wherein the discovery procedure comprises an IrLAP Fast Connect Address discovery procedure.

60. The method of claim 56 wherein the at least one infrared standard procedure comprises at least one of an address conflict resolution procedure and a sniff-open procedure.

61. The method of claim 55 wherein the point of sale terminal comprises an optical interface unit, the optical interface unit receiving the infrared signal.

62. The method of claim 51 wherein the system further comprises an optical interface unit for communicating the coupon information to the point of sale terminal.

63. The method of claim 55 wherein the step of receiving the infrared signal comprises an information exchange procedure.

64. The method of claim 51 wherein the coupon information comprises stock keeping unit (SKU) data.

65. The method of claim 51 further comprising the steps of securing the commercial information, the method comprising the steps of:
providing for receiving a random key index;
providing for identifying an encryption key corresponding to the random key index; and
providing for decrypting the commercial information utilizing the encryption key.

66. The method of claim 51 further comprising the step of providing for receiving a personal identification number corresponding to the commercial information.
